(19) United States
(12) Patent Application Publication
(10) Pub. No.: US 2011/0181971 A1
(43) Pub. Date: Jul. 28, 2011

(54) METHODS AND SYSTEMS FOR FABRICATING OPTICAL FILMS HAVING SUPERIMPOSED FEATURES

(76) Inventors: Alan B. Campbell, Santa Rosa, CA (US); Dale L. Ehnes, Cotati, CA (US); John F. Van Derlofske, III, Minneapolis, MN (US); Mark R. Dupre, Oakdale, MN (US); Patrick H. Marushin, Sartell, MN (US); Todd M. Johnson, St. Paul, MN (US)

(21) Appl. No.: 12/934,884

(22) PCT Filed: Apr. 1, 2009
(86) PCT No.: PCT/US09/39072

§ 371 Date: Apr. 13, 2011

Related U.S. Application Data
(60) Provisional application No. 61/041,763, filed on Apr. 2, 2008.

(51) Int. Cl. G02B 5/04; B26D 3/06; B29C 59/00

(52) U.S. Cl. 359/831; 83/875; 425/385

(57) ABSTRACT

An approach for making a master tool used to fabricate optical films involves cutting a series of base structures. Modifying features are superimposed with the base structures, producing abruptly discontinuous variations in the shape of the base structures. Diffraction elements may be formed in one or both of the base structures and the modifying features. The modifying features can be formed by moving the cutting tool in the x-direction, in the z-direction, or along a trajectory having both an x component and a z component.

### TECHNICAL FIELD

The present invention is related to the fabrication of master tools including base structures superimposed with modifying features, the master tools used to manufacture various types of micro-replicated components, including optical films.

### BACKGROUND

Master tools are used in the manufacture of micro-replicated components, including abrasive, adhesive, friction control, micro-fasteners, and optical components. For example, micro-replication features formed by machining a master tool can be transferred directly or indirectly to an optical film. The features transferred from the master tool form micro-replicated optical structures which affect the optical properties of the film. Optical films formed by such processes may be used for various purposes and are particularly useful in modifying the characteristics of visual displays. Display devices may use one or several different types of optical films having optical structures that enhance brightness, hide defects, increase light diffusion, improve contrast, and/or provide other desirable effects.

There is a need for fabrication processes and systems capable of producing enhanced master tools used to make various types of micro-replicated components. More specifically, there is a need for approaches used to manufacture optical films that increase desirable characteristics of displays while reducing the appearance of display defects. The present invention fulfills these and other needs, and offers other advantages over the prior art.

### SUMMARY

Some embodiments of the invention are directed to an optical film having base structures with a plurality of features superimposed on the base structures. Each of the base structures has a peak and each superimposed feature modifies a region of an underlying base structure by elevating the peak of the underlying base structure in that region. The radius of the peaks of the modifying features may be different from the radius of the peak of the underlying base structure. The base structures may vary in height and/or pitch, wherein these height and/or pitch variations are independent of any height and/or pitch variations produced by the modifying features.

According to certain aspects of the invention, the region modified by each feature has a perimeter associated with an abrupt discontinuity in the slope or shape of the underlying base structure. For example, the abrupt discontinuity may involve a taper angle or change in slope per micron of more than about 0.1 degrees, more than about 0.2 degrees or more than about 1 degree, for example. Each modifying feature may elevate the peak of the underlying base structure by about 0.5 microns to about 3 microns, for example.

In one implementation, the base structures are linear, triangular prisms with sharp-tipped peaks having an internal angle in a range of about 40 degrees to about 150 degrees. The elevated peaks in the regions of the modifying features may have a radius in the range of about 3 microns to about 8 microns.

In various implementations, diffraction elements may be disposed on one or both of the base structures and the modifying features. A plurality of additional features may modify sides of the base structures without substantially modifying the peaks of the base structures. Features that modify the base structures may do so along a majority of the peak-to-valley distance of the base structures and less than a majority of the length of the base structures.

Another embodiment is directed to an optical film having one or more base optical structures and a plurality of modifying optical features superimposed on the base structures. Each modifying feature elevates a peak of an underlying base structure. The radius of the peak in the regions of the modifying features is substantially equal to the radius of the peak of the underlying base structure.

Yet another embodiment is directed to an optical film that includes one or more elongated base structures and a plurality of discrete features superimposed on the elongated base structures. Each base structure has opposing sides and a peak. Each feature modifies at least one side of an underlying base structure for less than a majority of a length of the underlying base structure. In this embodiment, the features do not elevate the peaks of the underlying base structure.

According to certain aspects of the invention, each feature comprises a region associated with an abrupt discontinuity of the underlying base structure along the perimeter of the region. For example, the abrupt discontinuity may be associated with a taper angle of more than about 0.1 degrees, more than about 0.2 degrees, or more than about 1 degree, for example. In some implementations, each feature modifies the sides of the underlying base structure along a majority of the peak-to-valley dimension of the underlying base structure. Features may appear on only one facet or only on one side of a base structure, the other facet or side being devoid of the features.

A further embodiment is directed to an optical film comprising one or more base optical structures and a plurality of features superimposed on the base structures. The base structures have opposing sides and a peak. Each feature modifies an underlying base structure along a majority of a peak-to-valley distance of at least one side of the underlying base structure and less than a majority of the length of the underlying base structure. There is an abrupt discontinuity at a perimeter between each feature and the underlying base structure.

In some embodiments, each feature modifies both sides of the underlying base structure. In some embodiments, one or more of the features modifies a region of an underlying base structure by elevating the peak of the underlying base structure in that region. In some embodiments, the radius of the elevated peaks is different from a radius of the peak of the underlying base structure. For example, the radius of the elevated peaks produces by the modifying features may be greater that or less than a radius of the peak of the underlying base structure. In some implementations, diffraction elements are disposed on at least some of the modifying features and/or at least some of the base structures.

Another embodiment of the invention involves a method of modifying a surface to form a master tool for making optical films. A base feature comprising a groove is cut into the surface of the master. Either before or after the base feature is cut, one or more modifying features are cut into the surface of the master. The base feature and the modifying features are superimposed to produce abruptly discontinuous variations along the groove. For example, the base feature may be a continuous groove and the modifying features discrete features that modify the groove. In some implementations, diffraction elements may be formed in some of the base structures and/or some of the modifying features.

The abruptly discontinuous variations comprise variations in taper angle of more than about 0.1 degrees, more than about 0.2 degrees, or more than about 1 degree, for example. The modifying features may produce abruptly discontinuous variations in groove depth of about 0.5 microns to about 3 microns, for example.

Cutting the modifying features may involve moving a cutting tool substantially normal to the surface of the master tool to cause the cutting tool to incise into the groove. Cutting the modifying features may involve moving a cutting tool substantially parallel to the surface of the master tool to cause the cutting tool to incise more deeply into one or both sides of the groove. Cutting the modifying features may involve moving the cutting tool along a trajectory that includes a component parallel to the surface of master tool and a component normal to the surface of the master tool. The modifying features may comprise regions associated with an abrupt change in the slope of one or both sides of the groove without modifying a depth of the groove. Cutting the grooves and/or the modifying features may involve synchronized fly-cutting, dynamic synchronized fly-cutting, thread cutting, or plunge cutting, for example.

In some implementations, the grooves are cut using a first cutting tool that has a first cutting tool profile. The modifying features are cut using a second cutting tool that has a second cutting tool profile which is different from the first cutting tool profile. For example, the first cutting tool profile may have a cutting tip radius that is smaller than the cutting tip radius of the second cutting tool profile. The grooves and/or the modifying features may be cut using a cutting tool having a radiused, flattened, or blunted cutting tool profile.

According to some implementations, cutting the grooves and/or cutting the modifying features involves cutting the grooves and the modifying features by moving first and second cutting tools together in a single pass of a cutting head across the surface.

Another embodiment of the invention involves a system for modifying a surface to form a master tool for making optical films. The system includes one or more cutting tools. A drive system is configured to provide relative motion between the one or more cutting tools and the surface. A cutting mechanism is configured to control the cutting tools to cut a base feature comprising a groove in the surface of the master. The cutting mechanism is also configured to cut modifying features superimposed with the groove to produce abruptly discontinuous variations in a shape of the groove. The modifying features are usually cut after cutting the groove, however, the modifying features can be cut before cutting the groove.

The cutting mechanism may comprise a synchronized fly-cutting mechanism or a dynamic synchronized fly-cutting mechanism configured to control the cutting tools to make one or both of the base feature and the modifying features by synchronized fly-cutting. The cutting mechanism may include one or more cutting tools having a first profile used to cut the base feature and one or more second cutting tools having a second profile used to cut the modifying features. For example, at least one of the first profile and the second profile may have a radiused, flattened or blunted tip. The cutting mechanism may be configured to cut both the base features and the modifying features during a single pass of the first and second cutting tools across the surface. The first cutting tools and the second cutting tools are configured to move in synchrony.

In some implementations, the cutting mechanism is configured to cut the base feature during one or more first passes of the cutting tools across the surface and to cut the modifying features during one or more second passes of the cutting tools across the surface. In other implementations the cutting mechanism is configured to cut the base and modifying features by moving the cutting tools together during a single pass of the cutting tools across the surface.

Another embodiment involves a master tool useable for fabricating optical films, the master tool having a surface. A plurality of grooves and modifying features are superimposed on the surface of the master too. Each feature extends for less than a length of an associated groove and encompasses a region defined by an abrupt discontinuity in a slope of the associated groove at the perimeter of the region. For example, the abrupt discontinuity may have a taper angle in excess of about 0.1 degrees, more than about 0.2 degrees, or more than about 1 degree, for example.

In various configurations, one or more features modify the depth of the groove and an internal angle of the groove is different from, larger than, or smaller than an internal angle of the features. In some configurations, the features modify the depth of regions of a groove and a radius of the groove is smaller than the radius of the regions.

At least some of the features can modify sides of the grooves without modifying depths of the grooves. Some of the grooves may vary in depth and/or pitch. The features may modify the grooves along the peak to valley distance of the grooves. The features may or may not change the depths of the grooves.

Another embodiment of the invention is directed to a system for modifying a surface to form a master for making optical films. The system includes a first cutting tool configured to prepare the surface. A second cutting tool is configured to cut features in the surface. A drive system provides relative motion between the cutting tools and the surface. A cutting mechanism moves the first cutting tool and the second cutting tool to prepare the surface and cut the features during a single pass of the first and second cutting tools across the surface. The roughness of the surface after preparing the surface is substantially less than a smallest feature.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### DESCRIPTION OF THE DRAWINGS

FIG. 1 depicts an example of a portion of a film produced using a master tool manufactured in accordance with embodiments of the invention;

FIG. 2 is a diagram illustrating a turning system configured to manufacture a master tool having superimposed base structures superimposed with modifying features in accordance with embodiments of the invention;

FIG. 3 illustrates a coordinate system for machining a master tool in accordance with embodiments of the invention;

FIG. 4A is a perspective view of a tool tip carrier;

FIG. 4B is a front view of a tool tip carrier for holding a tool tip;

FIG. 4C is a side view of a tool tip carrier;

FIG. 4D is a top view of a tool tip carrier;

FIG. 5A is a perspective view of a tool tip;

FIG. 5B is a front view of a tool tip;

FIG. 5C is a bottom view of a tool tip;

FIG. 5D is a side view of a tool tip;

FIG. 6A illustrates a portion of a tool mount assembly configured to mount a cutting tool and dual single axis actuators to a turning machine

FIG. 6B is a diagram of an exemplary piezoelectric transducer (PZT) stack for use in a cutting tool actuator;

FIG. 7A is a diagram illustrating an interrupted cut used to create modifying features with substantially equal taper-in and taper-out angles into and out of a work piece;

FIG. 7B is a diagram illustrating an interrupted cut used to create modifying features with a taper-in angle less than a taper-out angle into and out of a work piece;

FIG. 7C is a diagram illustrating an interrupted cut used to create modifying features with a taper-in angle greater than a taper-out angle into and out of a work piece;

FIG. 8 is a diagram conceptually illustrating modifying features that can be made using an interrupted cut process in accordance with embodiments of the invention;

FIG. 9A shows a portion of a tool mount configured to mount a cutting tool and a single axis actuator to a turning machine for trajectory cutting in accordance with embodiments of the invention;

FIG. 9B illustrates the trajectory of the cutting tool in the X-Z plane for the single axis actuator arrangement as shown in FIG. 9A;

FIG. 9C illustrates a spacer mounted between the actuator and the cutting tool which is used to maintain the angle of the cutting tool tip substantially perpendicular to the surface of the master roll in accordance with embodiments of the invention;

FIG. 9D illustrates a tool shank for mounting a cutting tool to maintain the angle of the cutting tool tip substantially perpendicular to the surface of the master roll in accordance with embodiments of the invention;

FIG. 9E illustrates a cutting tool lapped to provide a cutting tool tip that is substantially perpendicular to the surface of the master roll in accordance with embodiments of the invention;

FIG. 10 shows a turning machine having a cutting mechanism capable of cutting superimposed base structures and modifying features in single pass over the surface of the master tool accordance with embodiments of the invention;

FIG. 11 is an exploded view of a fly-cutting head according to embodiments of the present invention;

FIG. 12 is an illustration of a fly-cutting system according to embodiments of the present invention;

FIG. 13A illustrates grooves formed by fly-cutting each groove longitudinally along the surface of the work piece;

FIG. 13B illustrates grooves formed by intersecting groove segments cut radially around the surface of the work piece;

FIG. 14 is an elevational perspective view of a fly-cutting head and a work piece, in which the head is inclined relative to the work piece;

FIG. 15 is an illustration of a cutting element mounted on an actuator according to embodiments of the present invention;

FIG. 16 is an illustration of a cutting element mounted on an actuator, in which the position of the cutting element and actuator can be further controlled by a second actuator in accordance with embodiments of the present invention;

FIG. 17A illustrates a tool tip geometry used to form base structures and/or modifying features on a master tool in accordance with embodiments of the invention;

FIGS. 17B and 17C illustrate base structures and/or modifying features on a master tool and optical film, respectively, that incorporates the tool tip geometry of FIG. 17A;

FIG. 18A illustrates a tool tip geometry used to form base structures and/or modifying features on a master tool in accordance with embodiments of the invention;

FIGS. 18B and 18C illustrate base structures formed on a master tool and optical film, respectively, that incorporate the tool tip geometry of FIG. 18A;

FIG. 19A illustrates a tool tip geometry used to form base structures or modifying features on a master tool in accordance with embodiments of the invention;

FIGS. 19B and 19C illustrate base structures formed on a master tool and optical film, respectively, that incorporate the tool tip geometry of FIG. 19A;

FIG. 20A illustrates a tool tip geometry used to form base structures or modifying features on a master tool in accordance with embodiments of the invention;

FIGS. 20B and 20C illustrate base structures formed on a master tool and optical film, respectively, that incorporate the tool tip geometry of FIG. 20A;

FIG. 21A illustrates a tool tip geometry used to form base structures or modifying features on a master tool in accordance with embodiments of the invention;

FIGS. 21B and 21C illustrate base structures formed on a master tool and optical film, respectively, that incorporate the tool tip geometry of FIG. 21A;

FIG. 22A is a side view of a tool tip with diffractive elements on both facets;

FIG. 22B is a side view of another tool tip with diffractive elements on both facets;

FIG. 23 is a side view of a tool tip with diffractive elements on one facet;

FIG. 24A is a side view of a tool tip with diffractive elements using step height variation;

FIG. 24B is a side view of another tool tip with diffractive elements using step height variation;

FIG. 25 is a side view of a tool tip with diffractive elements along 90° facet sides;

FIG. 26 is a side view of a tool tip with diffractive elements along a flat tip;

FIG. 27 is a side view of a tool tip with diffractive elements along a curved tip;

FIG. 28 is a side view of a tool tip with diffractive elements formed in steps;

FIG. 29 is a side view of a tool tip with diffractive elements having a lenticular shape;

FIG. 30 is a side view of a tool tip with diffractive elements along curved facets;

FIG. 31 is a side view of a tool tip with diffractive elements along multiple linear facets;

FIG. 32 illustrates base structures produced by cutting the master tool using low frequency movement of the cutting tool in the x direction to cause variations in height of the base structures in accordance with embodiments of the invention;

FIG. 33 illustrates an optical film structure configuration produced by cutting the master using low frequency movement of the cutting tool in the z direction causing variations in pitch in accordance with embodiments of the invention;

FIG. 34 illustrates a first set of base structures that vary in height along their length interleaved with a second set of base structures that vary in pitch along their length in accordance with embodiments of the invention;

FIG. 35 illustrates a base structures formed by cutting the master tool using low frequency z-direction movement of the cutting tool and high frequency x-direction movement of the cutting tool in accordance with embodiments of the invention.

FIGS. 36A and 36B illustrate base structures having x and z-axis excursions formed by cutting the master tool along a trajectory in accordance with embodiments of the invention;

FIG. 36C is a cross-sectional view of a structure having prisms with pitch variations without substantial height variations;

FIG. 37A illustrates a configuration with features that modify regions of the underlying base structure by elevating the peaks and introducing a radius to the peaks in the regions in accordance with embodiments of the invention;

FIG. 37B illustrates a configuration with features that modify regions of the underlying base structure by elevating the peaks and further wherein a radius of the peaks in the regions of the modifying features is different from the radius of the peaks of the base features in accordance with embodiments of the invention;

FIG. 38 illustrates a configuration with features that modify regions of the underlying base structure by elevating the peaks and where the modifying features also affect a majority of the peak-to-valley distance of the base structures in accordance with embodiments of the invention;

FIG. 39 illustrates a configuration including base structure grooves and modifying features that affect both sides of the grooves in accordance with embodiments of the invention;

FIG. 40, illustrates a configuration including base structure grooves and modifying features that affect only one side the grooves in accordance with embodiments of the invention;

FIG. 41A illustrates a configuration in which the modifying features include diffraction elements in accordance with embodiments of the invention;

FIG. 41B illustrates a configuration that includes base structures and two types of modifying features in accordance with embodiments of the invention;

FIG. 42 illustrates a configuration wherein the modifying features have curved sides and the peak internal angle in the regions of the modifying features is greater than the internal angle of the base features in accordance with embodiments of the invention;

FIG. 43 illustrates a configuration illustrating straight triangular prisms as base structures which are superimposed with modifying features and interleaved with prisms having pitch variations in accordance with embodiments of the invention;

FIG. 44 illustrates a structure that may be formed by variable depth grooves with a narrower included angle with a radius which form base prisms and recutting along the grooves with a continuous z-axis motion of the cutting tool in accordance with embodiments of the invention; and

FIGS. 45A-45C show photographic views at different magnifications of an optical film comprising a series of base structures superimposed with modifying features in accordance with embodiments of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, references are made to the accompanying drawings forming a part hereof, and in which are shown by way of illustration, various embodiments by which the invention may be practiced. It is to be understood that other embodiments may be utilized, and structural and functional changes may be made without departing from the scope of the present invention.

Master tools are used in the manufacture of optical and/or other types of micro-replicated films. For example, micro-replication features may be cut into the surface of a master tool as the negative, i.e., complement, of the desired optical structures. The master tool is then used to manufacture the films by forming the micro-replicated optical structures on the films through embossing, extrusion, cast and cure, and/or other processes, for example.

Optical films are particularly useful in controlling the optical properties of a backlit display. For example, a brightness enhancement film (BEF) uses optical structures to direct light along a desired viewing axis, thus enhancing the brightness of the light perceived by the viewer. A backlit computer display screen may use a number of different films in order to produce a screen with high contrast and high overall brightness, while simultaneously maintaining high, uniform brightness in certain selected directions and lower brightness in other directions. Such screens may use several types of films, such as diffusing films in combination with prismatic BEF films or lenticular films.

The cosmetic requirements for a display intended for close viewing, such as a computer display, are very high. Displays are viewed closely for long periods of time, and so even very small defects may be detected and cause distraction to the viewer. Physical defects include defects such as specks, lint, scratches, inclusions etc. Defects can also be associated with optical phenomena. Among the most common optical defects are “wet-out,” Newton's rings, and Moiré effects. In addition, under certain conditions, backlight components, such as extraction features, can be observable by the viewer through the display. Although these are intentionally placed features, when they become observable, they are similar to defects in that they degrade the display's appearance to the viewer.

Embodiments of the present invention are directed to methods and systems for machining master tools used to form optical films which have enhanced optical characteristics, making the films particularly advantageous for use in display applications. The approach involves a fabrication process that includes forming base structures in the master surface and forming modifying features superimposed with the base features. Although the base and modifying features may be formed in any order, the modifying features are so denoted for convenience because they modify the underlying structure of the base features. Master tools formed in accordance with embodiments of the invention allow the fabrication of unitary microstructure regions on a major surface of the optical films.

For example, in some embodiments, the base structures are continuous features and the modifying features are discrete features superimposed with the base features. In these embodiments, the length of the continuous base structures is significantly longer than the length of the discrete modifying features by many orders of magnitude. In some embodiments, the length of the base structures may not be significantly longer than the length of the modifying features. In one embodiment, the base features comprise triangular prisms and the modifying features modify the base structures in one or both of the x direction (perpendicular to the plane of the master surface) and the z direction (parallel to the plane of the master surface). The modifying features modify the base structure in regions defined by a perimeter where there is an abruptly discontinuous in the slope or shape of the base structures.

The modifying features may modify the tops and/or sides of the base structures. In some embodiments, the modifying features increase the depth of the base structure grooves. In some embodiments, the modifying features affect only the sides of the base structures without changing the height dimension. In yet other embodiments, the modifying features may increase the depth and modify the sides of the base structures.

Superimposition of the base structures and the modifying features may be employed to produce a combination of desirable optical properties in films formed from the master tool. A non-limiting, representative set of desirable optical properties that can be achieved using features that modify the base structure includes light direction and/or recycling along with enhanced light diffusion characteristics, improved durability and toughness, defect hiding and/or reduction of optical defects, along with additional advantageous properties described herein. In connection with brightness enhancement films, for example, the approaches of the present invention enhance the ability to manufacture optical films that are tailored to particular design criteria or a desired set of optical characteristics such as gain, toughness, diffusion, defect reduction, and defect hiding.

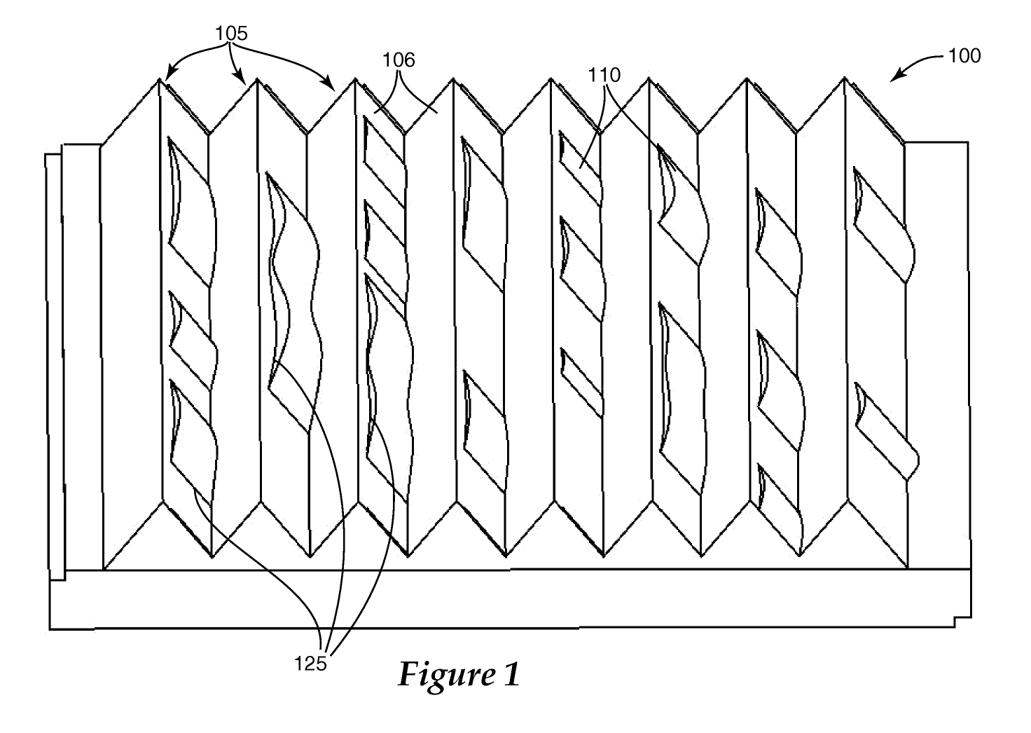

An example of a portion of a film 100 produced using a master tool manufactured by approaches described herein is illustrated in FIG. 1. In this example, as in other examples, the features formed in the master tool are the complement (negative) of the film features. Thus, the structures of the film and the structure of the master tool correspond such that local minima on the master surface correspond to local maxima on the film when the film is fabricated.

In this example, the film 100 typifies structures used for a light directing film, e.g., a light recycling brightness enhancement film. The film 100 includes base structures comprising a number of linear triangular prisms 105 corresponding to a groove cut into the master tool. Although in this example linear triangular prisms are illustrated as the base features, other prismatic or non-prismatic shapes are also applicable.

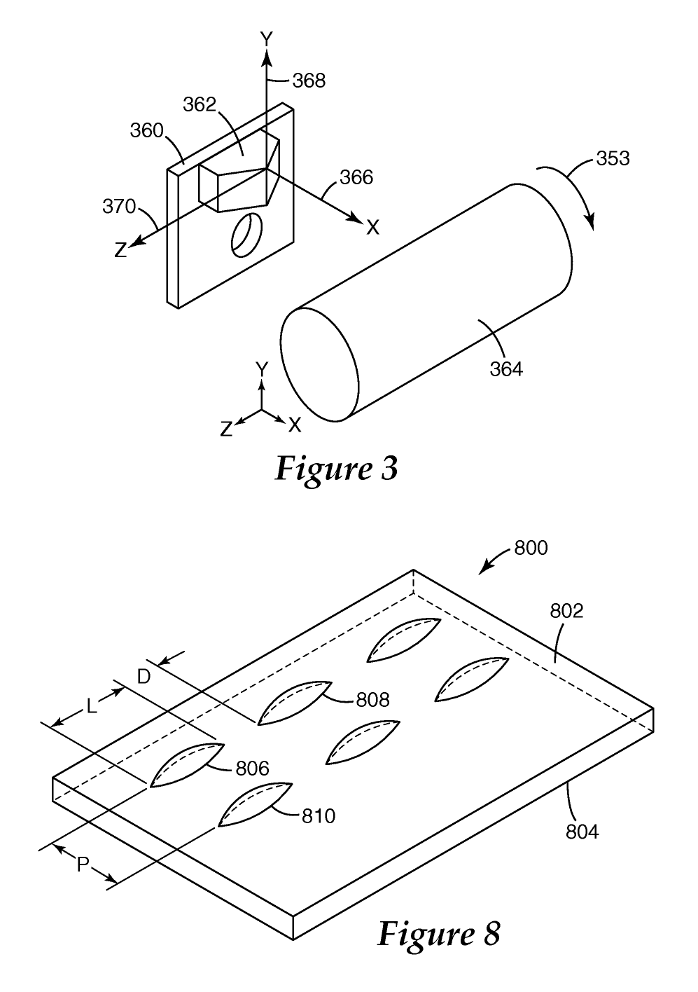

In the exemplary film 100, modifying features 110 are superimposed with the base structures 105 along the facets of the linear triangular prisms 105. As illustrated in FIG. 1, the modifying features 110 are associated with modification of the sides 106 of the underlying base structure defined by the linear prisms 105. In this example, the modifying features 110 can be formed by making discrete, interrupted cuts in the master tool at locations along the sides of the prism grooves. The interrupted cuts can be made by rapid movements of the cutting tool in the z direction parallel to the master tool surface, In addition or alternatively, rapid movements in the x direction, normal to the master tool surface can be made, or rapid movement of the cutting tool in a direction that has both an x component and a z component, or other movement of the cutting tool in such a way that causes the cutting tool to incise more deeply into the master tool surface than the underlying base structure. Interrupted cutting as it is described herein involves a process in which the cutting tool makes a discrete cut that produces a region defined by an abruptly discontinuous perimeter which alters the shape of a base feature. The coordinate system used for the film 100 and for the master tool is illustrated in FIG. 1 and is described in more detail in connection with FIG. 3.

Discrete optical features formed by the interrupted cutting technique described immediately form regions in the base structures defined by perimeters having an abrupt discontinuity from the shape of the underlying base structures. For example, the discrete features 110 form regions that have perimeters 125 where an abruptly discontinuous change in slope occurs at the sides 106 of the underlying triangular prisms 105. Formation of these abruptly discontinuous perimeters 125 can be achieved through dynamically controlled, interrupted cutting processes, including interrupted cutting by dynamically controlled plunge cutting or dynamically controlled synchronized fly-cutting as described in more detail herein.

Optical films incorporating modifying features having abruptly discontinuous perimeters can advantageously provide enhanced diffusion characteristics when compared with films that do not have such features. The superimposition of abruptly discontinuous modifying features on a base structure provides the ability to control the gain, optical diffusion, and/or defect reduction properties (e.g., anti-wetout and/or anti-Moiré), which enhances the ability to produce films designed for particular applications.

Continuous, non-interrupted cutting techniques, even though dynamically controlled, produce more gradual transitions making it difficult to form the abrupt discontinuities that provide the enhanced optical characteristics of the films described herein with non-interrupted cutting. The modifying features may be formed either before formation of the base structure or after formation of the base structure. The interrupted cuts may be made, for example by plunge cutting or fly-cutting which is dynamically controlled using a fast tool servo actuator.

In some embodiments, the base structures and/or modifying features are formed through the use of a turning machine. A turning machine may independently control the depth that the cutting tool penetrates into the master and the lateral motion of the cutting tool along the surface of the master. Additionally, the turning machine may independently control the rotational speed of a cylindrical master.

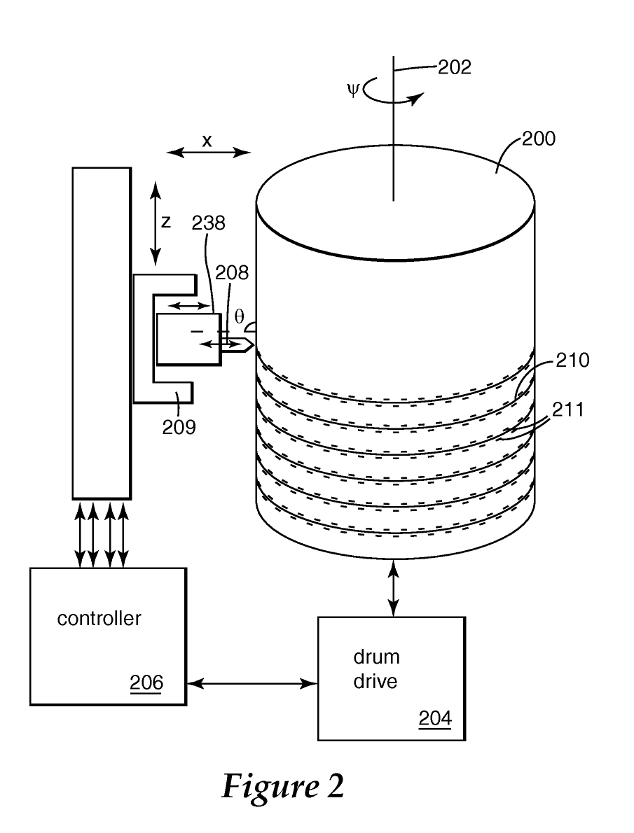

A turning system configured to manufacture a cylindrical master tool having superimposed base structures 210 and modifying features 211 in accordance with embodiments of the invention is illustrated in FIG. 2. A cylindrical master roll 200 is rotated around an axis 202 by a drum drive 204. Although, in this example, the master 200 is shown to be cylindrical in form, in alternative configurations, the master can be planar or take on other shapes. Base features 210 may be cut into the master 200 by plunge cutting concentric grooves or by thread cutting a groove on the master 200, i.e. translating the cutting tool 208 in the z direction while cutting into the surface of the master 200. Discrete cuts 211 forming the modifying features may be cut into the master superimposed with the base features 210. For example, the modifying features may be formed by interrupted cutting through rapid movement of a cutting tool 208.

In some implementations, a controller 206 drives the cutting tool mount 209 laterally in the Z direction to move the cutting tool 208 along the rotating master 200 to make a threaded cut or concentric cuts. The controller 206 controls the speed of the drum drive 204 and may monitor the angular position, Ψ, of the master 200.

In some embodiments, the cutting tool 208 may be oriented to cut continuous grooves 210 in the master 200 having a substantially constant depth and pitch. In other embodiments, the depth and/or pitch of the continuous features 210 may include “fast” and/or “slow” excursions. When cutting a continuous feature, “fast” excursions of the cutting tool may be used to produce films that have variations along the length of a particular continuous feature. “Slow” excursions of the cutting tool may be used to produce continuous features that vary from feature to feature.

For example, when cutting elongated v-shaped grooves, fast excursions of the cutting tool along the direction normal to the surface of the master surface can be used to produce films that exhibit variations in height along each prism. Slow excursions of the cutting tool along the direction normal to the surface of the master surface can be used to produce films that have prisms with constant height along the length of each prism, but have variations in height from prism-to-prism, so that a first prism has a different height from that of a neighboring prism. Continuous fast and slow excursions of the cutting tool may be used together when cutting the master, so that the films produced from the master include prisms that have continuous variations along the length of each prism in addition to a prism-to-prism variation. The fast and/or slow excursions may be made in any one or more of x, y, and z directions.

The controller 206 is configurable to control the movement of the cutting tool mount 209 to produce slow excursions of the cutting tool in the z direction, parallel to the master surface, and to produce slow excursions of the cutting tool in the x direction, normal to the surface of the master. Motion of the mount 209 may be used to produce variations in the surface cut into the master 200 that have an amplitude exceeding the stroke length of the fast servo actuators 238.

The controller 206 may also control the fast movement of the cutting tool 208 via one or more fast servo actuators 238 to produce fast excursions of the cutting tool which can form continuous high frequency variation in the depth and/or pitch of the grooves. Very rapid excursions of the cutting tool may also be used to make discrete, interrupted cuts 211 that form abruptly discontinuous features in the master 200. The interrupted cuts 211 may be made by movement of the cutting tool via the fast tool servo (FTS). Formation of the abruptly discontinuous features is possible through interrupted cutting wherein the cutting tool is rapidly inserted into the surface of the master tool and then withdrawn.

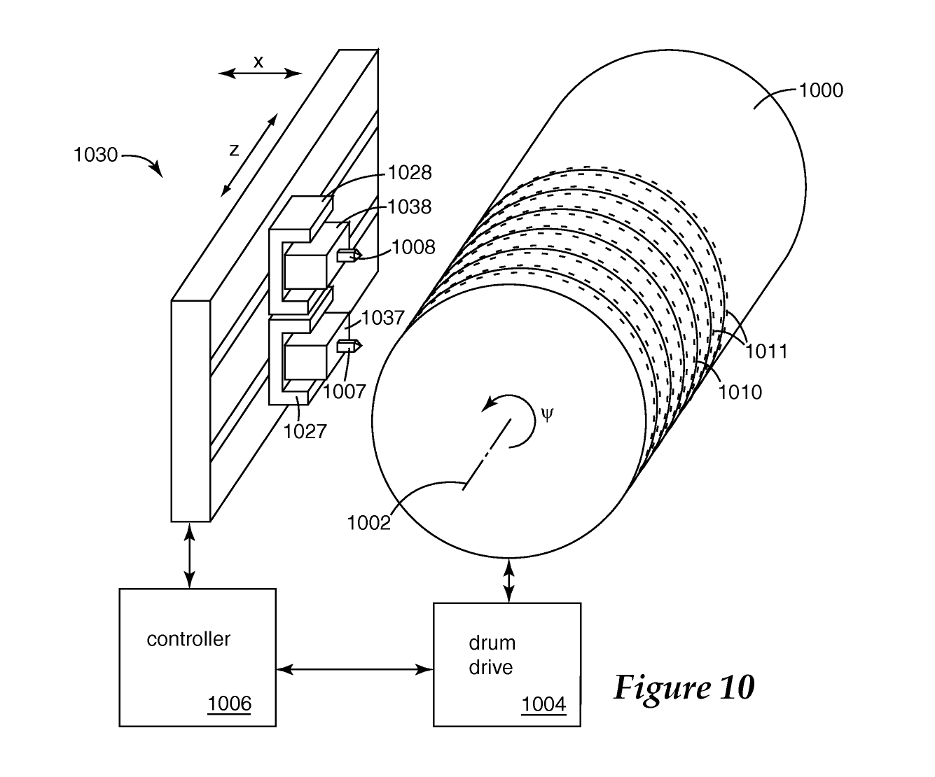

Superimposing the features formed by continuous cutting and those formed by interrupted cutting may be achieved in a single pass or multiple passes of a cutting head over the surface. For example, the base structure may be formed in one or more passes and the modifying features may be formed in another one or more passes. In some embodiments, multiple passes are made over the surface using the same cutting tool profile during each pass. In some embodiments, different profile cutting tools are used during different passes over the surface. In some embodiments, both the base structures and modifying the features may be cut in the master in a single pass using two or more cutting heads moving together over the master tool surface as illustrated in FIG. 10.

The angle, θ, between the cutting tool 208 and the master surface 200 can be controlled. The size and shape of the cutting tool 208 are selected depending on the particular type of film that the master 200 is to be used to manufacture.

The controller 206 generates control signals that control the movement of the cutting tool 208. For example, the controller 206 may generate signals directed to the mount 209 that move the cutting tool 208 in the x direction to cut substantially constant depth features in the surface of the master 200 or that move the cutting tool 208 in the z direction to cause the cutting tool 208 to cut grooves having substantially constant pitch by thread cutting or concentric groove cutting. The controller 206 may generate slow variation in signals directed to the tool mount 209 that produce corresponding slow variations in the depth of the features cut into the master 200. The controller may generate slow variation in signals directed to the tool mount 209 that produce corresponding slow variations in pitch between the grooves.

The controller 206 may provide signals to one or more fast tool servo (FTS) actuators 238 that further control the position of the cutting tool 208 in the x and/or z directions. The actuators 238 may be used to produce a continuous fast movement of the cutting tool 208 in the x and/or z directions. The actuators 238 may also provide very rapid motions of the cutting tool in the x and/or z directions to make interrupted cuts that form discrete, abruptly discontinuous modifying features 211.

Each modifying feature may have a length on the order of less than a micron, several microns, tens of microns, or greater length, for example. The modifying features may elevate the peak of the underlying base structure by about 0.5 microns to about 3 microns, for example.

The control signal generated by the controller 206 may be synchronous to the rotation of the master 200. Movements of cutting tool 208 may be regular or irregular. Regular movements of the cutting tool may be periodic or aperiodic. In some implementations, it is preferable to repeat the same signal for each master tool, such that they contain the same pattern and the resultant structure is the same roll to roll. Under control of the controller, the cutting tool may be moved in a way that produces a random pattern or a pseudorandom pattern.

The one or more actuators 238 can operate to move the cutting tool 208 at speeds not normally obtainable by movement of the cutting tool mount 207. Each actuator 238 comprises a single axis fast tool servo, having a transducer, such as a piezoelectric transducer (PZT), or other transducer for converting an electrical signal from the controller 206 into movement of the actuator 238 which ultimately controls the motion of the cutting tool 208. The cutting tool 208 may be controlled by one or multiple single axis actuators 238 so that movement in both x and z directions is possible.

The upper frequency limit of the fast servo actuator's response may lie in the range from several kilohertz to many tens of kilohertz, whereas the frequency response of the cutting tool mount 209 is typically not greater than 5 Hz. For example, movement of the tool mount 209 may achieve a low frequency variation in groove pitch of about 0.5 microns to about 50 microns over a distance (wavelength) of about 500,000 microns. Movement of the tool mount 109 may achieve a low frequency variation in groove depth of about 0.5 microns to about 50 microns with a wavelength of about 2,000,000 microns. The length of the stroke that the actuator 238 produces may be, for example, less than 50 microns, or in a range of about 0.5 micron to about 50 microns with a wavelength of about 5 microns to about 500 microns. It will be appreciated that there may be a trade-off between length of stroke and upper frequency response.

Micro-replication master tools may be formed as cylindrical rolls having features that are complementary to the desired optical shapes, including the base features and abruptly discontinuous modifying features illustrated herein. Although the master is illustrated herein as a cylindrical roll, it may alternatively take other shapes, such as planar, curved, convex or concave. The surface of the master is typically of hard copper, although other materials such as aluminum, nickel, steel, or plastics (e.g., acrylics) may also be used.

Once a micro-replication master tool has been formed, it may be used as a master to create micro-replicated optical films. The optical films may be made using a tool prepared according to the present invention by methods such as casting and curing a polymeric material on the tool, embossing, extrusion, compression molding, and/or injection molding. Casting-and-curing is generally preferred, and the materials from which the optical films may be made include polycarbonate and polyethylene terephthalate (PET). The optical films may be made in a single layer (monolithic), or may include two or more layers, such that a backing layer comprises one material and a microstructured layer comprising the base structures and the modifying features (grooves and/or other structures) comprise another material. The microstructured layer may be formed as a unitary structure using the master tools fabricated as described herein.

In some embodiments of the present invention, the structure of the master tool can be transferred on other media, such as to a belt or web of polymeric material, by a cast and cure process to form a production tool. This production tool is then used to make a micro-replicated article of the type described herein. This results in an article having a surface that corresponds to the surface of the master tool. Other methods, such as electroforming, can also be used to copy the master tool. That copy, which may be referred to as an intermediate tool, can then be used to produce the micro-replicated article.

FIG. 3 is a diagram illustrating a coordinate system for a cutting tool such as cutting tool 208 illustrated in FIG. 2. The coordinate system is illustrated for movement of a tool tip 362 with respect to a work piece 364. Tool tip 362 is typically attached to a carrier 360, which is attached to an actuator (not shown). The coordinate system, in this exemplary embodiment, includes an x direction 366, a y direction 368, and a z direction 370. Movement in the x direction 366 refers to movement in a direction substantially perpendicular to work piece 364. Movement in the y direction 368 refers to movement in a direction transversely across work piece 364 such as in a direction substantially perpendicular to an axis of rotation of work piece 364. Movement in the z direction 370 refers to movement in a direction laterally along work piece 364 such as in a direction substantially parallel to the axis of rotation of work piece 364. The rotation of the work piece is referred to as the c direction, as represented by arrow 353. If the work piece is implemented in planar form, as opposed to roll form, then the y direction and z direction refer to movement in mutually orthogonal directions across the work piece in directions substantially perpendicular to the x direction. A planar form work piece can include, for example, a rotating disk or any other configuration of a planar material.

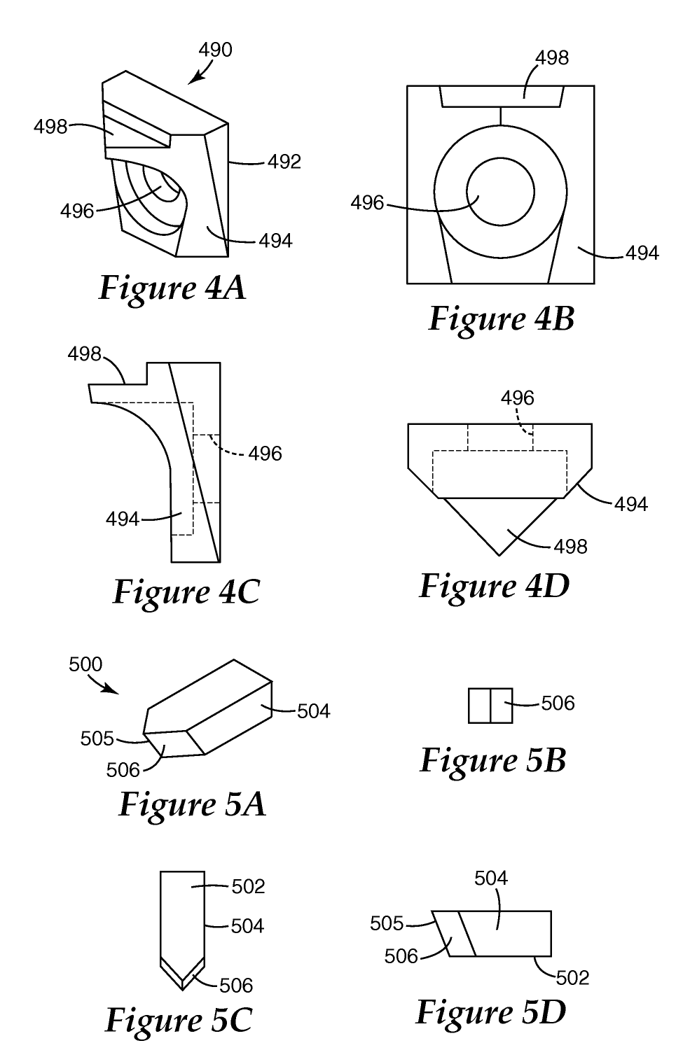

FIGS. 4A-4D are views of an exemplary tool tip carrier 490, which would be mounted to a PZT stack for control by an actuator. FIG. 4A is a perspective view of tool tip carrier 490. FIG. 4B is a front view of tool tip carrier 490. FIG. 4C is a side view of tool tip carrier 490. FIG. 4D is a top view of tool tip carrier 490.

As shown in FIGS. 4A-4D, tool tip carrier 490 includes a planar back surface 492, a tapered front surface 494, and a protruding surface 498 with angled or tapered sides. An aperture 496 provides for mounting of tool tip carrier 490 onto a post of a PZT stack. Tapered surface 498 would be used for mounting of a tool tip for machining of a work piece. In this exemplary embodiment, tool tip carrier 490 includes a planar surface to enhance stability of mounting the tool tip carrier 490 by providing for more surface area contact when mounted to a PZT stack. Tool tip carrier 490 includes the tapered front surfaces to reduce the mass. Tool tip carrier 490 can be mounted to a post of the PZT stack by use of an adhesive, brazing, soldering, a fastener such as a bolt, or in other ways.

Other configurations of tool tip carriers are possible based, for example, upon requirements of particular embodiment. The term “tool tip carrier” is intended to include any type of structure for use in holding a tool tip for machining a work piece. Tool tip carrier 490 can be implemented with, for example, one or more of the following materials: sintered carbide, silicon nitride, silicon carbide, steel, titanium, diamond, or synthetic diamond material. The material for tool tip carrier 490 preferably is stiff and has a low mass.

FIGS. 5A-5D are views of an exemplary tool tip 500, which would be secured to surface 498 of tool tip carrier 490 such as by use of an adhesive, brazing, soldering, or in other ways. FIG. 5A is a perspective view of tool tip 500. FIG. 5B is a front view of tool tip 500. FIG. 5C is a bottom view of tool tip 500. FIG. 5D is a side view of tool tip 500. As shown in FIGS. 5A-5D, tool tip 500 includes sides 504, tapered and angled front surfaces 506, and a bottom surface 502 for securing it to surface 498 of tool tip carrier 490. The front portion 505 of tool tip 500 is used for machining of a work piece under control of an actuator. Tool tip 500 can be implemented with, for example, a diamond slab. Tool tip 500 can be made to have a variety of configurations to achieve various cutting profiles as illustrated in more detail below.

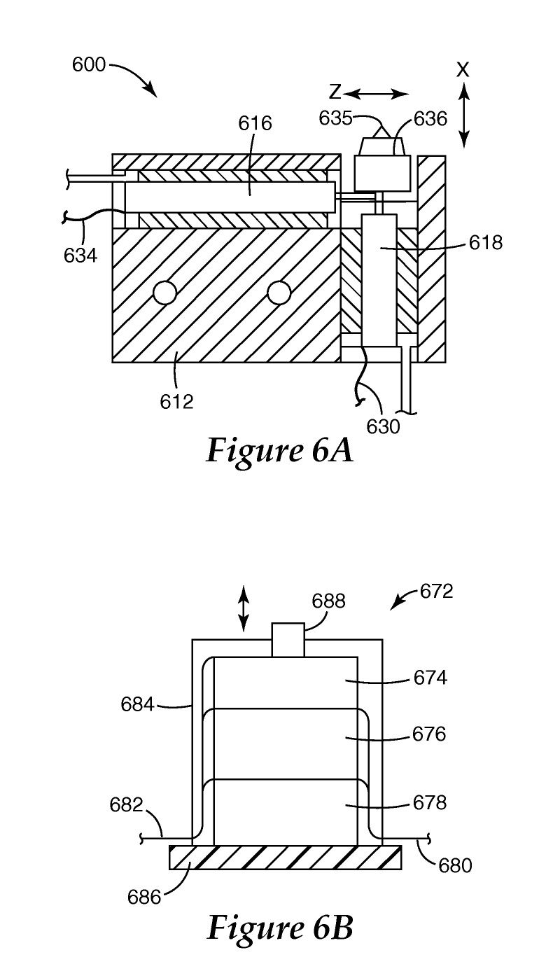

FIG. 6A illustrates a portion of a tool mount assembly 600 that is used to mount a cutting tool 635, tool tip carrier 636 and fast tool actuators 618, 616 to a turning machine. The tool mount assembly 600 includes a main body 612 capable holding an x-direction actuator 618, a z-direction actuator 616, and the cutting tool 635. In this example, the actuators 616, 618 are PZT stacks. The PZT stacks 618, 616 are arranged to move the cutting tool 635 in the x-direction and z-direction, respectively. In some applications, only one PZT stack may be used. The PZT stacks 618, 616 are securely mounted to the tool mount assembly 612 for the stability required for precise controlled movement of cutting tool 635. PZT stacks 618, 616 include electrical connections 630, 634 for receiving signals from the controller. PZT stacks 618, 616 can include one or more Belleville washers positioned between the stacks and the tool tip carrier 636 for preloading.

FIG. 6B is a diagram of an exemplary PZT stack 672 for use in a cutting tool. A PZT stack is used to provide movement of a tool tip connected to it and operates according to the piezoelectric effect, which is known in the art. According to the piezoelectric effect, an electric field applied to certain types of materials causes expansion of them along one axis and contraction along another axis. A PZT stack typically includes a plurality of materials 674, 676, and 678 enclosed within a casing 684 and mounted on a base plate 686. The materials in this exemplary embodiment are implemented with a ceramic material subject to the PZT effect. Three disks 674, 676, and 678 are shown for exemplary purposes only and any number of disks or other materials, and any type of shapes of them, can be used based upon, for example, requirements of particular embodiments. A post 688 is adhered to the disks and protrudes from casing 684. The disks can be implemented with any PZT material such as for example, a barium titanate, lead zirconate, or lead titanate material mixed, pressed, based, and sintered. The disks can also be implemented with a magnetostrictive material, for example.

Electrical connections to the disks 674, 676, and 678, as represented by lines 680 and 682, provide electrical fields to them in order to provide for movement of post 688. Due to the PZT effect and based upon the type of electric field applied, precise and small movement of post 688, such as movement within several microns, can be accomplished. Also, the end of PZT stack 672 having post 688 can be mounted against one or more Belleville washers, which provides for preloading of the PZT stack. The Belleville washers have some flexibility to permit movement of post 688 and a tool tip attached to it. Systems using multiple actuators for cutting a master tool are described in U.S. patent applications Ser. Nos. 11/274723, 11/273875, 11/273981, and 11/273884, all of which were filed Nov. 15, 2005.

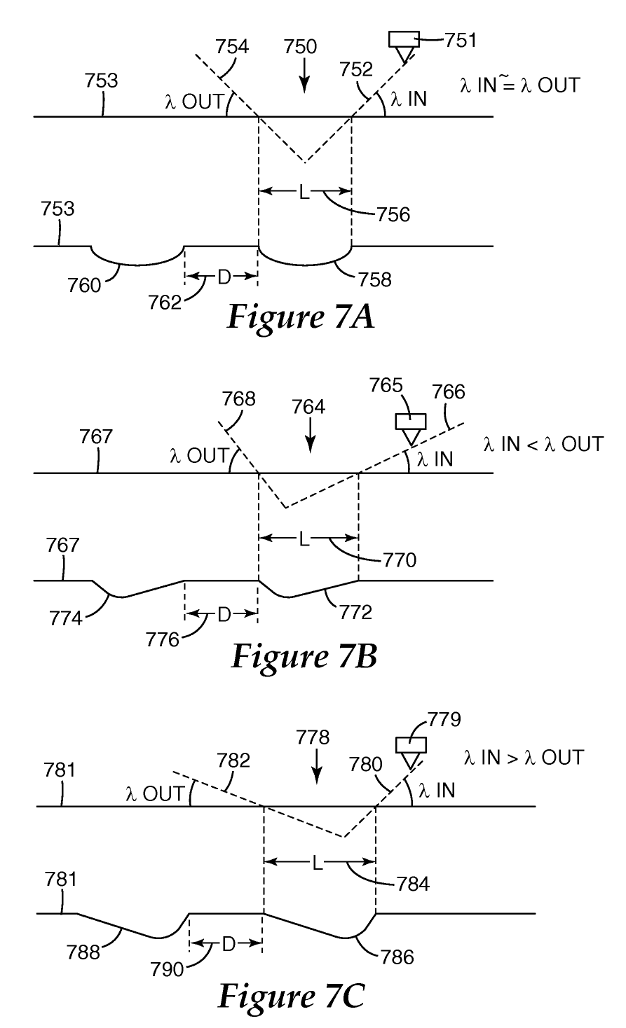

FIGS. 7A-7C illustrate interrupted cut machining of a master tool by plunge cutting using the exemplary actuator and system described above. In particular, FIGS. 7A-7C illustrate use of variable taper-in and taper-out angles of a tool tip, and those angles can be controlled through control of the movement of the master and the cutting tool. Each of FIGS. 7A-7C illustrate examples of the master before and after being cut with varying taper-in and taper-out angles. The taper-in angle is referred to as λ_{IN} and the taper-out angle is referred to as λ_{OUT}. The terms taper-in angle and taper-out angle mean, respectively, an angle at which a tool tip enters a work piece and leaves a work piece during machining The taper-in and taper-out angles do not necessarily correspond with angles of the tool tip as it moves through a work piece; rather, they refer to the angles at which the tool tip contacts and leaves the work piece. In FIGS. 7A-7C, the tool tips and masters can be implemented, for example, with the system and components described above.

FIG. 7A is a diagram illustrating an interrupted cut 750 with substantially equal taper-in and taper-out angles into and out of a work piece 753. As shown in FIG. 7A, a taper-in angle 752 of a tool tip 751 into a work piece 753 is substantially equal to a taper-out angle 754 (λ_{IN}≈λ_{OUT}). The duration of the tool tip 751 into work piece 753 determines a length L (756) of the resulting microstructure. Using substantially equal taper-in and taper-out angles results in a substantially symmetrical microstructure 758 created by removal of material from the work piece by the tool tip. This process can be repeated to make additional microstructures, such as microstructure 760, separated by a distance D (762).

FIG. 7B is a diagram illustrating an interrupted cut with a taper-in angle less than a taper-out angle into and out of a work piece 767. As shown in FIG. 7B, a taper-in angle 766 of a tool tip 765 into a work piece 767 is less than a taper-out angle 768 (λ_{IN}<λ_{OUT}). The dwell time of the tool tip 765 in work piece 767 determines a length 770 of the resulting microstructure. Using a taper-in angle less than a taper-out angle results in an asymmetrical microstructure, for example microstructure 772, created by removal of material from the work piece by the tool tip. This process can be repeated to make additional microstructures, such as microstructure 774, separated by a distance 776.

FIG. 7C is a diagram illustrating an interrupted cut with a taper-in angle greater than a taper-out angle into and out of a work piece 781. As shown in FIG. 7C, a taper-in angle 780 of a tool tip 779 into a work piece 781 is greater than a taper-out angle 782 (λ_{IN}>λ_{OUT}). The dwell time of the tool tip 779 in work piece 781 determines a length 784 of the resulting microstructure. Using a taper-in angle greater than a taper-out angle results in an asymmetrical microstructure, for example microstructure 786, created by removal of material from the work piece by the tool tip. This process can be repeated to make additional microstructures, such as microstructure 788, separated by a distance 790.

In FIGS. 7A-7C, the dashed lines for the taper-in and taper-out angles (752, 754, 766, 768, 780, 782) are intended to conceptually illustrate examples of angles at which a tool tip enters and leaves a work piece. While cutting the work piece, the tool tip can move in any particular type of path, for example a linear path, a curved path, a path including a combination of linear and curved motions, or a path defined by a particular function. The path of the tool tip can be chosen to optimize cutting parameters such as total time to complete cutting the work piece.

Embodiments of the invention are directed to processes that rely on interrupted cutting to form modifying features comprising regions defined by a perimeter where there is an abrupt discontinuity in the slope of the underlying base structure. For example, the abrupt discontinuity may involve a taper in or taper out angle (or change in slope per micron) of more than about 0.1 degrees, more than about 0.2 degrees or more than about 1 degree, for example. Each modifying feature may incise into the base structure in the x or z directions by about 0.5 microns to about 3 microns. The modifying features may range in length from less than a micron to several microns to tens of microns.

FIG. 8 is a diagram conceptually illustrating microstructures in a film that can be made using the cutting tool system having an interrupted cut FTS actuator to make a machined work piece and using that work piece to make a structured film. As described herein, the features similar to microstructures 806, 808, and 810 may be superimposed on base features.

As shown in FIG. 8, an article 800 includes a top surface 802 and a bottom surface 804. Top surface 802 includes interrupted cut microstructures such as structures 806, 808, and 810, and those microstructures can be made using the actuators and system described above to machine a work piece and then using that work piece to make a film or article using a coating technique. In this example, each microstructure has a length L, the sequentially cut microstructures are separated by a distance D, and adjacent microstructures are separated by a pitch P. Additional illustrations involving films having interrupted cut microstructures such as those illustrated in FIG. 8 superimposed with on base structures are illustrated herein.

In some embodiments, either the variation in the continuous cutting motion of the cutting tool when forming the base structure, the tool tip motion that produces the modifying cuts, or both, may involve motion along a trajectory that has both x and z components with respect to the surface of the master. In some embodiments, cutting along a trajectory, referred to herein as trajectory cutting, may include one x-axis actuator and another z-axis actuator as illustrated by the tool mount assembly of FIG. 6A. In some embodiments, trajectory cutting can be accomplished using a single-axis actuator aligned with respect to the cutting trajectory.

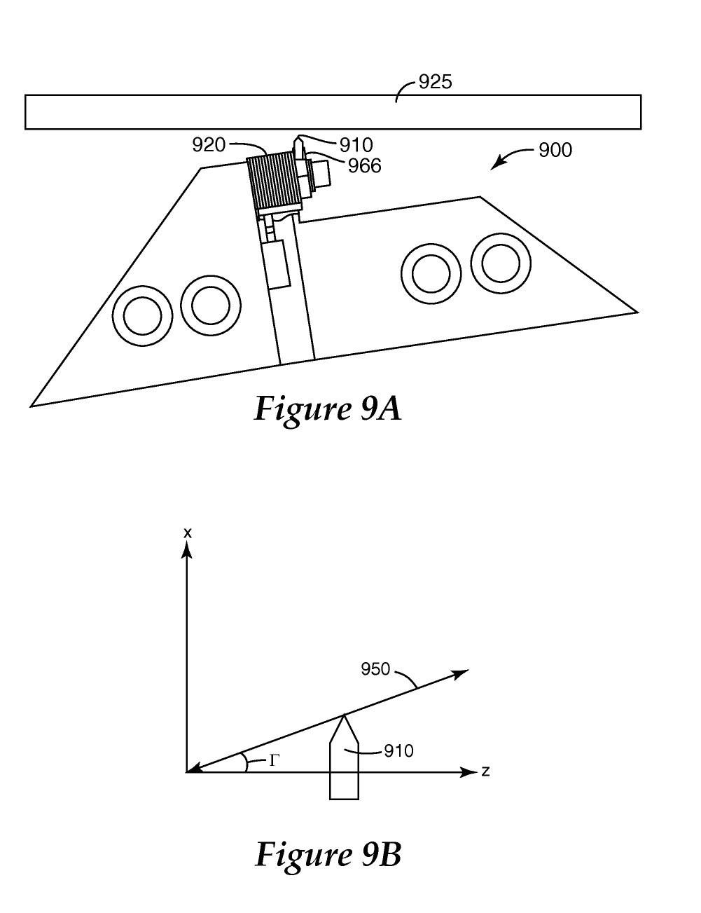

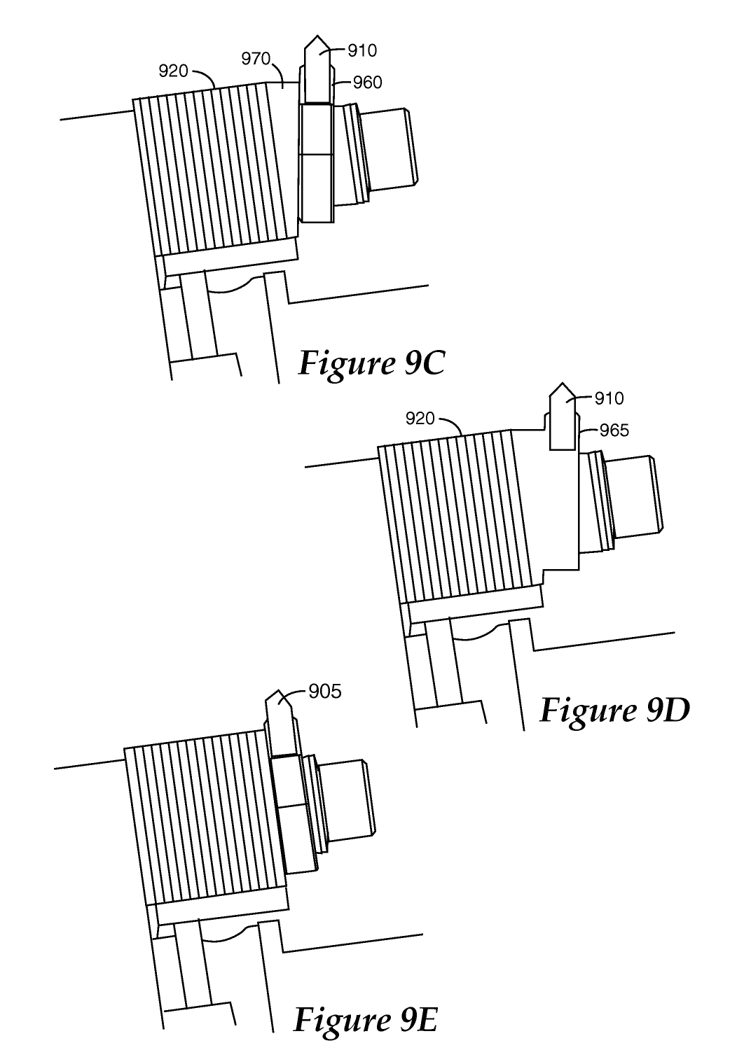

FIG. 9A shows a portion of a tool mount 900 configured to mount a cutting tool 910 and a single axis actuator 920 to a turning machine. The cutting tool 910 and the actuator 920 are oriented so that operation of the actuator 920 (e.g., a PZT actuator) produces a trajectory motion of the cutting tool 910. Operation of the PZT actuator 920 moves the cutting tool 910 along a trajectory that has both x and z components and is off axis with the surface of the master.

FIG. 9B illustrates the trajectory 950 of the cutting tool 910 in the x-z plane for the single axis actuator arrangement as shown in FIG. 9A. When cutting the base structures, the cutting tool 910 can be moved back and forth along the trajectory 950 to cut variable depth and variable pitch grooves in the surface of the master tool. When modifying a base structure, trajectory cutting may be implemented to cut into the sides of the base structures, as illustrated, for example, by the structure of FIG. 40. The trajectory 950 can be tuned for a single axis actuator depending on the amount of x component and z component desired. The maximum hypotenuse length is dictated by the single axis actuator travel capability.

For example, for a PZT stack capable of 20 microns of travel, the actuator could be rotated such that 3 microns of x-axis component is produced. With the x axis component equal to 3 microns, and the hypotenuse equal to 20 microns, then the actuator is oriented with respect to the master surface at an angle, Γ, of 8.6 degrees. Using the Pythagorean theorem, the z axis component is calculated to be 19.7 microns.

The tip of the cutting tool 910 may be oriented perpendicular to the surface of the master or may be oriented at an angle to the master surface. The tool tip orientation may be achieved many ways. As illustrated in FIG. 9C, an orienting spacer 970 may be employed between the PZT actuator 920 and tool shank 360. As illustrated in FIG. 9D, the tool shank 965 may include the desired geometry directly. The tool 910 may be oriented on the shank 966 at the desired angle, as illustrated in FIG. 9A. The tool tip 905 may be lapped or formed to contain the desired orientation as shown in FIG. 9E.

As previously discussed, the turning machine, cutting tools and techniques illustrated in FIGS. 2-9 may be used to cut the base structure and/or the modifying features by any one or more of the various methods. For example, cutting the base structure and the modifying features may be performed in a multi-step process that involves using the turning machine to first cut a threaded continuous groove or a sequence of concentric grooves in the master, and then using the turning machine to superimpose discrete features on the previously cut grooves. Alternatively, the modifying features may be cut in the surface of the master surface initially, followed by a step that cuts a threaded groove or concentric grooves superimposed over the modifying features.

In yet another example, the base structure and the modifying features may be cut in single pass or in multiple passes using a turning machine having a cutting mechanism that includes two or more cutting tools. FIG. 10 illustrates a turning machine having a cutting mechanism 1030 with two cutting tools 1007, 1008 that may be implemented for cutting base structures and modifying features in a single pass of the cutting tools 1007, 1008 over the master surface 1000. Although for purposes of illustration only two cutting tools are illustrated in FIG. 10, any number of cutting tools may be used in this manner.

As the master tool rotates under control of the drum drive 1004 around axis 1002, under control of the controller 1006, one of the cutting tools 1008, 1007 may be used to make the base structures such as by making a continuous cut producing grooves 1010 in the surface 1000 of the master tool. Another of the cutting tools 1007, 1008 may be used to make the modifying features 1011, such as by making interrupted cuts. In some embodiments, the continuous cut may produce grooves 1010 having constant depth and pitch. In other embodiments, the continuous cut may produce grooves 1010 which include fast or slow variations in depth and/or pitch.

The turning machine of FIG. 10 illustrates a cutting mechanism 1030 that incorporates cutting tools 1007, 1008, associated tool mounts, 1027, 1028, and associated actuators 1037, 1038. Independent fast and/or slow movements of each cutting tool 1007, 1008 along the x and/or z axes is possible. Slow movement of each cutting tool 1007, 1008 may be accomplished independently for each cutting tool 1007, 1008 by independent movement of their respective tool mounts 1027, 1028. In some embodiments, both cutting tools 1007, 1008 are attached to a common tool mount. In some embodiments, the tool mounts 1027, 1028 can be coupled together, causing both the coupled tool mounts 1027, 1028 to move both cutting tools 1007, 1008 together.

Each of the cutting tools 1007, 1008 may be independently operated by one or more tool actuators 1037, 1038 providing fast motion of the cutting tools. Movement of the cutting tools 1007, 1008 in three dimensions along x, y, and/or z axes may be independent or non-independent producing fast excursions of one or both cutting tools 1007, 1008. The fast motions may be used to make continuous variations in the depth and/or pitch of the grooves 1010 or may be used to accomplish plunge cutting to form abruptly discontinuous interrupted cuts which produce discrete features 1011.

For example, each cutting tool 1007, 1008 may be operated independently by one or both an x axis actuator and a z axis actuator. Alternatively, each cutting tool 1007, 1008 may be operated by a single axis actuator to move along a trajectory that includes both x and z components as described above.

Additional information regarding the use of cutting continuous and/or discrete features in a master tool which are applicable to embodiments of the present invention are described in commonly owned U.S. patent applications identified by Ser. No. 11/952438 filed Dec. 7, 2007 and Ser. No. 60/974245 filed Sep. 21, 2007.

In some embodiments, one of the cutting tools 1008 illustrated in FIG. 10 may be used to prepare the surface 1000 and another of the cutting tools 1007 may be used to cut features into the prepared surface. For example, preparation of the surface 1000 may include smoothing the surface, texturing the surface and/or cutting continuous features, discrete features, triangular grooves, lenticular structures, pyramids, hemispheres, truncated structures and/or other features or combinations thereof into the surface. The second cutting tool 1007 may be employed to modify the surface prepared using the first cutting tool 1008. For example, the modification of the surface by the second cutting tool 1007 may involve forming continuous and/or discrete features or various combinations of continuous and/or discrete features. In some implementations, the roughness of the surface after preparing the surface is substantially less than a smallest feature.

In some embodiments, cutting the base structures and/or modifying features may be accomplished by fly-cutting. Fly-cutting uses a rotating fly-cutting head to bring a cutting tool into contact with the surface of the master. As the fly-cutting head is rotated, the cutting tool periodically cuts into the work piece. The fly-cutting head and the work piece can be moved relative to each other, which enables the cutting element to cut a long groove into the work piece, for example. For example, if the work piece is a cylindrical roll, a fly-cutting head can cut a groove down the length of the outer surface of the roll, the roll can be indexed by a distance equal to the spacing or pitch between grooves, and then another groove can be cut down the length of the roll adjacent to the first groove. In this manner, an entire roll can be provided with base structures, such as continuous longitudinal grooves. Fly-cutting may also be used to form a number of modifying features on the master surface by moving the cutting head in relation to the work piece and making cuts at discrete locations of the master surface.

Fly-cutting, which is a type of milling, is typically a discontinuous cutting operation, meaning that each cutting element is in contact with the work piece for a period of time, and then is not in contact with the work piece for a period of time during which the fly-cutting head is rotating that cutting element through the remaining portion of a circle until it again contacts the work piece. Although a fly-cutting operation is typically discontinuous, the resulting groove or other surface feature formed in a work piece by the fly-cutter may be continuous (formed by a succession of individual, but connected cuts, for example) or discontinuous (formed by disconnected cuts), as desired.

As noted above, the feature(s) cut into the work piece using fly-cutting may be a groove, formed by the sequential groove segments made by the cutting elements as the head rotates, that extends longitudinally along the length of the work piece. In this arrangement, it is not important to know where an individual cutting element is relative to the axis of rotation of the fly-cutting head, because the cutting element simply continues to cut material from the work piece until it is moved away from the work piece, or the motor is stopped.

Another example of a similar arrangement is when a fly-cutter is used to cut a helical groove into the surface of a cylindrical work piece—a process that produces a threaded groove in the master surface. In that situation as well, the position of any individual cutting element relative to the axis of rotation of the fly-cutting head is unimportant, because the cutting elements once positioned relative to the work piece simply continues to cut that work piece until they are stopped. In other words, if the point at which a cutting element first contacts the work piece is said to be 0 degrees (relative to the axis of rotation of the fly-cutter head), it is not important to know whether a cutting element is located at 5 degrees, 165 degrees, or 275 degrees of rotation around the axis of rotation at any point in time.

In some fly-cutting embodiments, it is necessary to determine of the position of a fly-cutting head with respect to the work piece as a function of time. This information is useful for fly-cutting operations in which the fly-cutting head is to be positioned to form an element of a continuous feature, such as a groove segment, or a discrete feature in a work piece in a specified position relative to the work piece or other features, or both. The position determination may be absolute, meaning that the rotational position of the fly-cutting head is known relative to some initial or reference point, or relative, meaning that the rotational position of the fly-cutting head is known relative to some previous position. For example, using the simple angular position descriptions provided above, some embodiments of a fly-cutting system enable a user or a system to determine that at a first point in time (t₁), the cutting element was at a first angular position (a₁), that at a second point in time (t₂) the cutting element was at a second angular position (a₂), and so on. If the angular positions are specified as the positions at which, for example, a cutting element first contacts a work piece (at position a₁), and the position at which a cutting element has cut a known portion of a groove or other feature into the work piece (position a₂), then a fly-cutting head equipped with an actuator for changing the position or the orientation of a cutting element, or both, between position a₁ and position a₂ can be activated to do so. In short, knowing the position of the cutting element as a function of time permits an operator to specify the position of that cutting element at any point in time, which can enable the system to form continuous and/or discrete features in a work piece.

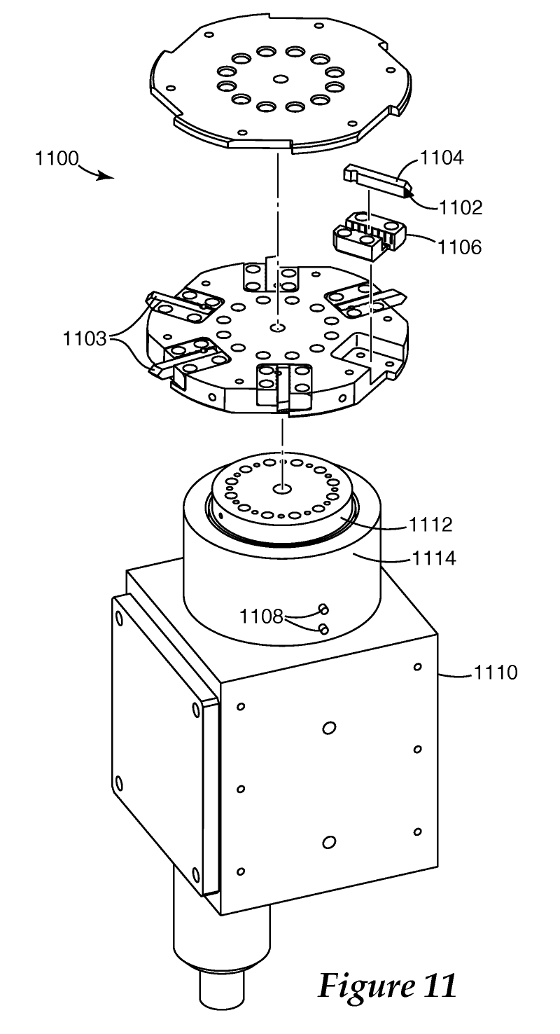

In an embodiment of a fly-cutting system and method which is shown in FIG. 11, the fly-cutting head 1100 includes cutting elements 1102, 1103 that are retained by or incorporated into shanks or tool holders 1104, which may in turn be affixed to head 1100 by cartridges 1106. The cutting elements 1102, 1103 may be a diamond, for example, that is carried by a tool holder 1104. Alternatively, a cutting element such as a diamond may be bonded directly to a fly-cutting head or disc, and used to form features in a work piece. In some embodiments, the cutting element 1102 may have a different profile geometry than that of the cutting elements 1103. The cutting elements 1103 may be used to cut base structures in the master tool work piece and the cutting element 1102 may be used to cut the modifying features, for example.

The fly-cutting head 1100 includes a housing 1110 that is normally secured to a base or platform, a motor such as a DC motor that includes a stator (not shown) that is affixed to the housing, and a rotating spindle 1112 that is supported by an air-bearing 1114, which may include ports 1108, for example. The fly-cutting head 1100 may also include a slip-ring or other assembly for transmitting signals or power or both between stationary and rotating portions of the head.

The fly-cutting head 1100 also includes an encoder, such as rotary encoder that measures the position (or change of position) of the rotating spindle relative to the housing 1110. One part of the encoder is typically stationary, and is in a fixed position relative to (and typically contained within) the housing or the stator or both. A second part of the encoder is typically affixed to a rotating portion of the fly-cutting head such as spindle 1112, and it is adapted to interact with the stationary part of the encoder to produce a signal that indicates relative movement between the two parts. For example, the rotating part of the encoder may have a series of lines or other indicia, and the stationary part of the encoder may optically detect the presence or absence of those lines in order to determine the extent of the relative motion between the two parts. The encoder (the stationary part, typically) then transmits at least one position signal that includes information regarding the position of the fly-cutting head, which can be received by a controller and used to create command signals. The command signals may be transmitted to the motor associated with the fly-cutting head or platform, for example. Command signals may change the speed of the fly-cutting head, or its location relative to the work piece, for example.

Although in the present description reference may be made to a single cutting element that is carried by a fly-cutting head, multiple cutting elements may be carried by the fly-cutting head, and the cutting elements may be identical to or different from each other. The cutting elements may be single or polycrystalline diamond, carbide, steel, cubic boron nitride (CBN), or of any other suitable material. Suitable diamond cutting tips are available from the K&Y Diamond Company of Quebec, Canada. The geometry of a cutting element such as a diamond, and the design of a shank or holder for the cutting element, may be specified to create the surface features or effects desired for a work piece. The cutting element, which is typically replaceable, may include more than one cutting tip, or other features, as described for example in U.S. Patent Publication No. 2003/0223830 (Bryan et al.), the contents of which are incorporated herein. Diamond cutting elements can be milled on a sub-micron scale, including for example by ion-milling, to create cutting elements that will form features of almost any desired configuration. Other characteristics of the fly-cutting head can be selected as desired. For example, a larger diameter fly-cutting head can be used to create grooves that naturally have a flatter bottom, due to the larger cutting radius, than grooves cut by a smaller diameter fly-cutting head.

A fly-cutting system in accordance with the present invention is illustrated in FIG. 12. For ease of description, a coordinate system may be designated with regard to the fly-cutting head 1200 and a work piece 1299. The coordinate system designations are arbitrary, and provided to facilitate an understanding of the present invention in the context of the drawings provided, rather than to limit the scope of the invention. The coordinate system is shown relative to the tip of the cutting element, and includes mutually orthogonal x, y, and z axes. Consistent with the coordinate system previously discussed, the x axis is perpendicular to roll 1299, and in the illustrated embodiment passes through the longitudinal axis of roll 200. The y axis extends vertically, as shown in FIG. 12, and in the illustrated embodiment is parallel to or coincident with a tangent to the outer surface of the roll. The z axis extends horizontally and parallel to the central axis of the roll.

The work piece, in the illustrated embodiment, also has a rotational axis c, and the work piece may be rotated in either direction with respect to that axis. The fly-cutting head 1200 has an axis of rotation A, which is parallel to the y axis in FIG. 12. Although the illustrated work piece is a cylindrical roll, and the designation of a work piece and a roll may be used interchangeably in this description where the specific shape of the work piece is unimportant, work pieces of other shapes and sizes may be used in connection with the present invention. If the work piece is planar (such as a plate or disc) rather than cylindrical, then corresponding adaptations in the preceding designations of the various axes may be made to facilitate an understanding of the invention in that context.

In this embodiment, a cylindrical work piece 1299 is fixedly supported on a spindle 1225, and an encoder 1226 is positioned and adapted to detect the position or change in position of the spindle relative to a fixed or initial point. The work piece may be a roll 1299 made of metal, such as stainless steel, with an outer layer made of a material that is more easily tooled, such as brass, aluminum, nickel phosphorus, hard copper, or polymer. For simplicity, the work piece will often be referred to in this description as a “roll,” but the work piece could with suitable adaptations to the system be planar, convex, concave, or of a complex or other shape. Accordingly the term “roll” in this description is intended to exemplify work pieces of any suitable shape.

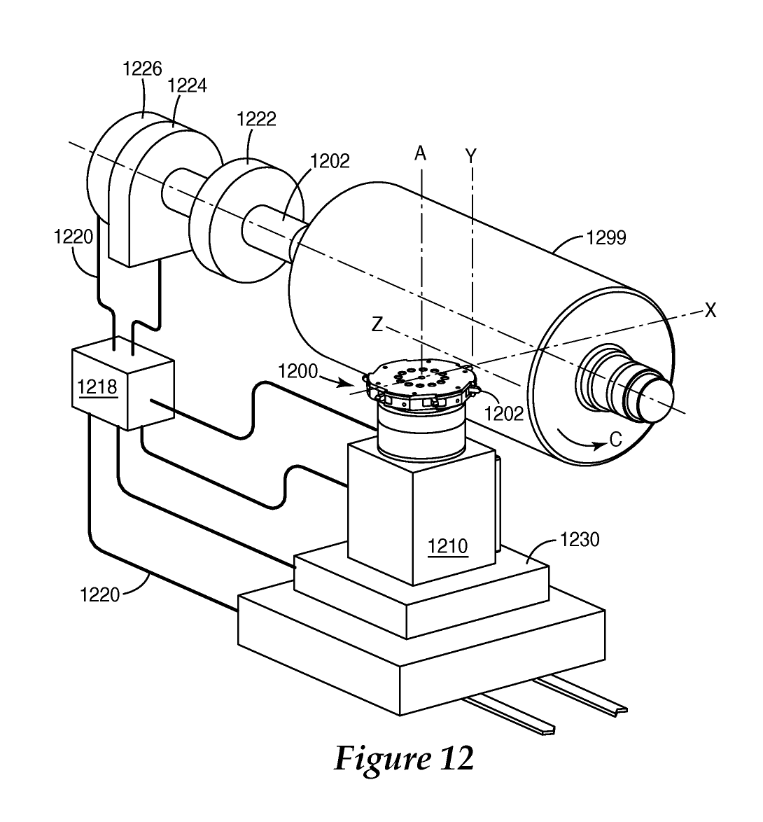

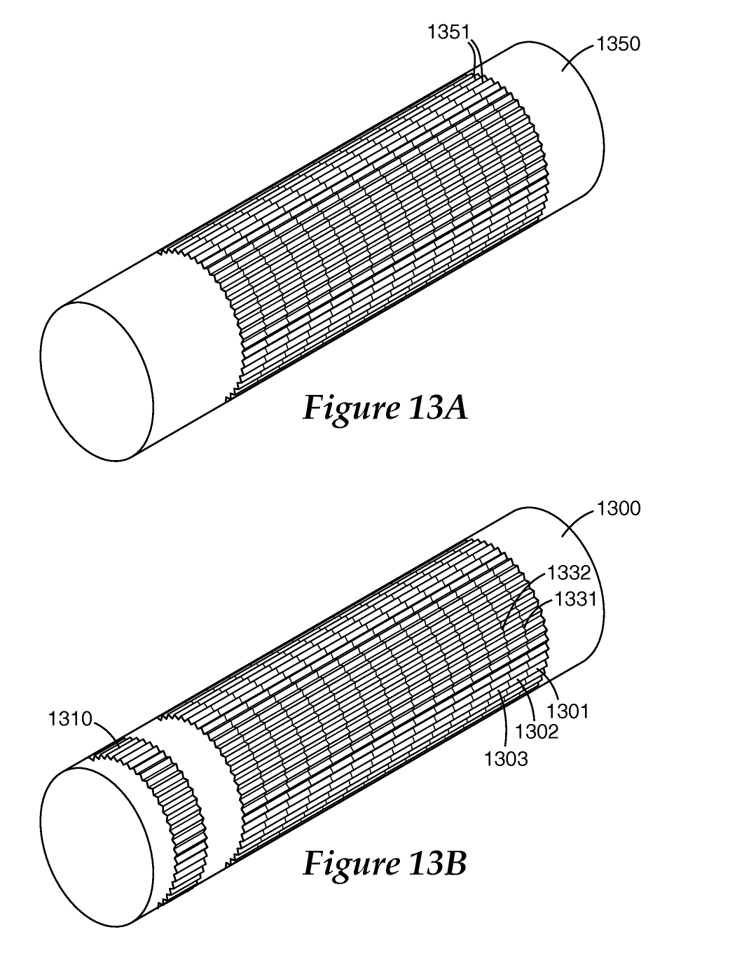

The work piece may include a test band 1310 at one end, as shown in FIG. 13B, on which the fly-cutting head can be programmed to cut a test pattern to determine whether the head and the work piece are positioned and synchronized appropriately relative to each other. The characteristics of the features formed in the test band can then be evaluated, and once the operation of the fly-cutting head and the work piece have been optimized, the actual machining operation can be performed on a different portion of the work piece. Test bands are not required, but they may be useful for determining what adjustments may have to be made to cause the actual performance of the system to match the desired or theoretical performance of the system.

The fly-cutting system is preferably controlled by a computer or controller 1218, which may include or be operatively connected to memory for storing one or more applications, secondary storage for non-volatile storage of information, a function generator for generating waveform data files that can be output to an actuator or other device, an input device for receiving information or commands, a processor for executing applications stored in memory or secondary storage or received from another source, a display device for outputting a visual display of information, or an output device for outputting information in other forms such as speakers or a printer, or any combination of two or more of the foregoing. The controller may exchange data or signals using cables 1220, or a suitable wireless connection. One useful control system includes input and output circuitry, and a PMAC control, available from Delta Tau Data Systems of Chatsworth, Calif.. That PMAC control combines a multi-axis PMAC2 controller with amplifiers to provide motion control of, for example, the fly-cutting head and the roll.

The control system of the present invention uses software or firmware or both that can be designed in a manner known to produce the results described herein. Specifically, the software preferably enables an operator to create waveform data files that represent both the micro-level shape of an individual groove segment or other surface feature, and a macro-level pattern (regular or irregular, periodic or aperiodic) of groove segments and/or discrete features on the work piece. Those data files are then communicated to the various control system components to control the performance and preferably the synchronization of the cutting elements relative to the work piece.

To program and coordinate the movement of the various components, software is typically used to input the desired parameters to create data files, and a wave generation unit then translates the data files into signals that are transmitted to the drive unit(s), actuator(s) and other components as required. For example, the roll speed may be set at from approximately 0.001 to approximately 1000 revolutions per minute, and the fly-cutting head speed may be set at from approximately 1000 to approximately 100,000 revolutions per minute. Fly-cutting head speeds of approximately 5000, approximately 10,000, approximately 25,000 revolutions, and approximately 40,000 revolutions per minute have been tested, and are generally preferred because higher speeds reduce the time required to create a finished work piece, such as a micro-replication master tool.

The work piece 1299 in the illustrated embodiment may be fixedly supported on a spindle system that is driven by a motor that is controlled by and receives command signals from the controller. The spindle system may include one or more bearings 1222, such as air or hydrostatic bearings. For simplicity, bearings 1222 are shown at only one end of the roll in FIG. 12, although they may be positioned and supported in any suitable location with respect to a work piece 1299. The roll may be rotated in either direction by a motor 1224 or, if the work piece 1299 is not cylindrical or is positioned using a different system, positioned in response to instructions provided by the controller 1218. An exemplary motorized spindle system is available from Professional Instruments of Hopkins, Minn., under the designation 4R, or under the designation 10R (which includes an air bearing), or, for larger work pieces, an oil hydrostatic spindle system from Whitnon Spindle Division, Whitnon Manufacturing Company, of Farmington, Conn. The spindle system preferably also includes a rotary encoder 1226 that is adapted to detect the position of the work piece 1299 to within a desired degree of accuracy, and to transmit that information to the controller to enable the controller to synchronize the work piece 1299 and the fly-cutting head 1200 in the manner described below.

The fly-cutting head 1200 is preferably supported on a fly-cutting table 1230, as shown in FIG. 12, which may be referred to as an “x-table.” The x-table 1230 is adapted for movement along at least one of the x, y, and z axes, preferably along both the x and z, and more preferably along all three of the x, y, and z axes sequentially or preferably simultaneously, to position the fly-cutting head 1200 and the cutting element(s) 1202 relative to the work piece 1299. As is known in the art, the x-table 1230 can move in more than one dimension or direction essentially simultaneously, so that the location of the cutting tip 1202 can be easily positioned in three-dimensional space under the control of the controller 1218.

Other conventional machining techniques may useful in connection with the inventive system and its components. For example, cooling fluid may be used to control the temperature of the cutting elements 1202, the fly-cutting head 1200, the actuators (not shown), or other components. A temperature control unit may be provided to maintain a substantially constant temperature of the cooling fluid as it is circulated. The temperature control unit and a reservoir for cooling fluid can include pumps to circulate the fluid through or to the various components, and they also typically include a refrigeration system to remove heat from the fluid in order to maintain the fluid at a substantially constant temperature. Refrigeration and pump systems to circulate and provide temperature control of a fluid are known in the art. In certain embodiments, the cooling fluid can also be applied to the work piece 1299 to maintain a substantially constant surface temperature while the work piece 1299 is being machined. The cooling fluid can be an oil product, such as a low-viscosity oil.

Other aspects of the machining process are also known to persons of skill in the art. For example, a roll may be dry-cut, or cut using oil or another processing aid; high-speed actuators may require cooling; clean, dry air should be used with any air bearings, such as those that support the spindle; and the spindle may be cooled using an oil cooling jacket or the like. Machining systems of this type are typically adapted to account for a variety of parameters, such as the coordinated speeds of the components and the characteristics of the work piece material, such as the specific energy for a given volume of metal to be machined, and the thermal stability and properties of the work piece material. Finally, certain diamond-turning components and techniques of the type described in PCT Publication WO 00/48037, and fly-cutting components and techniques of the type described in U.S. Patent Publication 2004/0045419 A1 (Bryan et al., which is assigned to the assignee of the present invention) may also be useful in the context of the present invention.

The position of the work piece 1299 as a function of time is determined, for example in the case of a cylindrical roll by using an encoder 1226 associated with a spindle on which the roll 1299 is fixedly mounted for rotation about a longitudinal axis of rotation. The encoders used for the fly-cutting head, and for the spindle or other work piece support system, may be used not only for purposes of measuring speed, as with some conventional encoders used with fly-cutting systems, but to measure position. Then encoder can then transmit a position signal indicative of the position of the fly-cutting head or the spindle, respectively. This assists in synchronizing the positions of the work piece 1299 and the cutting element(s) 1202 of the fly-cutting head 1200. Specifically, encoders may be provided to determine the rotational position of a roll, the position of the fly-cutting head 1200 with respect to its axis of rotation of the head, the position of the fly-cutter head 1200 with respect to another axis such as the z axis, and the position of an x-table 1230 that moves the fly-cutter 1200 with respect to the roll 1299. Accordingly, although the term “determining the position” of the fly-cutting head 1200 will commonly be used with reference to determining its position during rotation of the head 1200, it may additionally include determining the position of the fly-cutting head 1200 with respect to its axial position along or rotational position around an axis. In general, the fly-cutting head 1200 may be angled with respect to, or rotated around (or tilted with respect to), any axis.

In one embodiment, this synchronization may be done by providing a position encoder (such as an angular encoder) associated with the work piece 1299 and another position encoder associated with the fly-cutting head 1200. At least two types of encoders are currently available—incremental and absolute. Incremental encoders may be less expensive, and if used with an index signal that is indicative of a known position of the roll or the fly-cutting head, for example, may function effectively as an absolute encoder. The encoder 1226 associated with the work piece 1299 (or the spindle on which the roll is mounted) should have a resolution sufficient to detect the position of the work piece 1299 along its axis of rotation to within a fraction of the desired groove pitch or other dimension of the features being machined into the work piece 1299. The groove pitch is the distance from the center of one groove to the center of the next adjacent groove, or the distance from one peak to the next adjacent peak, and a corresponding dimension can normally be calculated for other surface features.

One encoder useful in connection with the fly-cutting head in certain embodiments of the present invention is available from U.S. Digital Corp. of Vancouver, Wash., under the designation E5D-100-250-I, and it is positioned on the fly-cutting head to measure the angular position of the head. An encoder that is useful in connection with the work piece or roll in certain embodiments of the present invention is available from Renishaw Inc. of Hoffman Estates, Ill., under the designation Renishaw Signum RESM, 413 mm diameter, 64,800 line count. The particular encoder(s) 1226 selected for an application depends on the desired resolution, maximum speed of the fly-cutting head 1200 or other component, and the maximum signal speed.

The depth of the features cut into a work piece surface may be in the range of 0 to 150 microns, or preferably 0 to 35 microns, or even more preferably for creating micro-replication tools for optical films, 0 to 15 microns, or 0 to 3 microns. These ranges are not intended to limit the scope of the invention, but they may represent the scale of features useful for providing certain optical effects in films produced using such a tool. For a roll work piece, the length of any individual feature is influenced by the speed at which the roll rotates around its longitudinal axis, because it is more difficult to cut a long feature into a roll moving at a higher speed. If the cutting elements are moving in the opposite direction of the work piece, longer grooves may generally be formed more easily than if the cutting elements are moving in the same direction as the work piece. A continuous feature can have almost any length as individual cuts are concatenated to produce continuous features. For example, the fly-cutting head of the present invention may be used to create a continuous feature approximating a thread cut around the perimeter of a cylindrical roll. For discrete features, their length may be from about 1 micron to several millimeters, for example, although this range is not intended to limit the scope of the present invention. For thread-cutting, the pitch or spacing between adjacent grooves can be set at from about 1 to about 1000 microns. The features can have any type of three-dimensional shape such as, for example, symmetrical, asymmetrical, prismatic, and semi-ellipsoidal features.

Microstructures created using the actuators and system described in the present specification can have a 1000 micron pitch, 100 micron pitch, 1 micron pitch, or even a sub-optical wavelength pitch around 200 nanometers (nm). Alternatively, in other embodiments, the pitch for the microstructures can be greater than 1000 microns. These dimensions are provided for illustrative purposes only, and features or microstructures made using the actuators and system described in the present specification can have any dimension within the range capable of being tooled using the system.

In cases in which the work piece is a cylindrical roll that is rotating around its longitudinal axis, a fly-cutting head that is arranged to cut a groove or succession of grooves parallel to that axis may need to be re-oriented so that the resulting groove or succession of grooves is actually parallel. In other words, if the cutting element would cut a parallel groove in the roll when the roll is stationary, then it would (if other parameters were held constant) cut a slightly curved groove in the roll if the roll is permitted to rotate during the cut. One way to offset this effect is to angle the cutting head so that the cutting element at the end of its cut is farther in the direction of rotation of the roll than at the beginning of its cut. Because the cutting element is in contact with the roll over only a short distance, the result can be to approximate a parallel cut in the roll surface notwithstanding the rotation of the roll. It may be possible to adapt the system in other ways to accomplish the same or a similar objective, for example by enabling the fly-cutting head to rotate around the central axis of the roll so that it follows the roll as it rotates, although this may be expensive to implement.

In one useful system and method for machining a work piece, such as the cylindrical work piece 1299 shown in FIG. 12, the fly-cutting head 1200 is positioned with its axis of rotation A extending parallel to the Y axis, so that grooves or features that extend parallel to the Z axis are cut into the surface of the work piece 1299.

To form a master tool according to various embodiments, a work piece 1299 such as a cylindrical roll is milled to provide the desired surface features. The blank roll may have an outer layer into which structures or patterns will be cut. That layer, after it has had a random or other pattern cut into it, may in turn be coated with one or more additional layers that protect the pattern, permit accurate formation of a film or its easy release, or perform other useful functions. For example, a thin layer of chrome or a similar material may be applied to the tool, although a layer of that type may “round over” sharp edges of the tool and therefore be undesirable. Any machineable materials could be used; for example, the work piece can be made of aluminum, nickel, copper, brass, steel, or plastics (such as acrylics). The particular material to be used may depend, for example, upon a particular desired application such as various films made using the machined work piece.

In one embodiment, the fly-cutting head 1200 is moved longitudinally with respect to the work piece 1299 to cut an entire groove down the length of the work piece 1299. The rotation of the work piece 1299 is then incremented, and another groove is cut down the length of the work piece 1299. Grooves 1351 in the master roll 1350 produced by this process are illustrated in FIG. 13A.

In another embodiment, a single groove segment is cut and the work piece is rotated by a distance (at the outer surface) equal to the desired pitch, or distance, between the desired location of adjacent grooves. Then a second groove segment is cut, and the work piece rotated by a second distance equal to the pitch between the desired location of the next adjacent grooves. This process is repeated until groove segments have been formed around the perimeter of the work piece. When the work piece has been rotated through an entire revolution, the controller (because it has received the position signals sent by the encoder associated with the work piece) can precisely align groove segments cut into the work piece during the steps in a successive revolution with the groove segments cut in steps in a preceding revolution, to form the equivalent of longitudinally-extending grooves or other desired structures in the outer surface of the work piece.

FIG. 13B illustrates an idealized work piece 1300, in which individual groove segments 1301 have been formed by fly-cutting during a first revolution of the work piece, after which groove segments 1302 have been formed during a second revolution, after which groove segments 1303 have been formed during a third revolution, and so on. The groove segments formed during the second and subsequent revolutions are aligned with the groove segments formed during the first revolution, and the result is continuous longitudinal grooves extending between a first end and a second end. It is possible to extend the groove segments and resulting grooves across the entire length of the work piece, but it may be desirable to leave areas on each end of the roll blank, for the formation of test bands or for other purposes.

Although cutting successive groove segments into a work piece around its perimeter is believed to have certain advantages when compared to conventional fly-cutting operations, the visual appearance of the areas of the work piece where successive groove segments overlap may be undesirable. These feature overlaps are shown at 1331 (where groove segments formed during the second revolution overlap with groove segments formed during the first revolution), 1332 (where groove segments formed during the third revolution overlap with groove segments formed during the second revolution), and so on along the length of the roll. It may be desirable to minimize visual or non-visual effects of the overlap regions to improve the optical performance of articles made on the tool.

The position of the fly-cutting head is determined using encoder, as noted above, and the position of the spindle on which the work piece 1299 is carried is similarly determined using an encoder 1226 in FIG. 12. Because the cutting elements are typically in a fixed position relative to the fly-cutting head, and the work piece is typically in a fixed position relative to the spindle, knowing the position of the fly-cutting head and the spindle essentially enable an operator to know the position of the cutting elements and the work piece. Data from those encoders is fed into controller 1218, as shown in FIG. 12, which can in turn transmit command signals to the motor that creates the rotary motion of the fly-cutting head, or the motor that creates the Z-axis motion of the fly-cutting head, or the motor that creates the rotational motion of the spindle on which the work piece is carried, or more than one of the foregoing, for example. When the relationship between the position of the fly-cutting head and the work piece has been determined, the fly-cutting head may be said to be electronically “geared” to the work piece, because no actual mechanical gearing between the two pieces exists. When a fly-cutting head is electronically geared to a work piece according to the present invention, the controller can determine when in the orbit of a cutting element it strikes the work piece, and where on the work piece it strikes. In a further aspect of the invention described in detail in the copending United States Patent Application above, a user can also cause the controller to change the position or orientation of a cutting element relative to the fly-cutting head if the cutting element is connected to an actuator capable of creating such motion. For example, a user may program the controller to create a groove segment with an essentially linear bottom in a work piece, by activating an actuator that can change the position of the cutting element thousands of time per second so that it follows a predetermined cutting path.

When the positions of both the fly-cutting head and the work piece are controlled, in practice one is normally set to rotate at a fixed or predetermined speed and the other is geared to it (e.g. slowed down or speeded up) so that the two are in the correct positions relative to each other. Because the fly-cutting head operates at several thousand revolutions per minute, it has a considerable amount of energy, inertia, and/or momentum, and it may not be practical to attempt to speed up or slow down the head to match the position of the work piece. Instead, the fly-cutting head may be programmed to rotate at essentially a fixed rate, and the spindle on which the work piece is carried may be speeded up or slowed down so that the cutting element and the work piece are in the proper positions relative to each other. This system may be referred to as one in which the fly-cutting head is the “master,” and the work piece and its corresponding spindle are “slaved” to it. The reverse is also possible—slaving the fly-cutting head to the work piece—as is a third embodiment in which the rotation of the fly-cutting head, the rotation of the work piece, and the z-axis motion of the fly-cutting head are all under synchronized control. Experimental testing of the fly-cutting system on the test strip part of the work piece is typically helpful in determining whether the head and the work piece are appropriately geared together to produce the desired results.

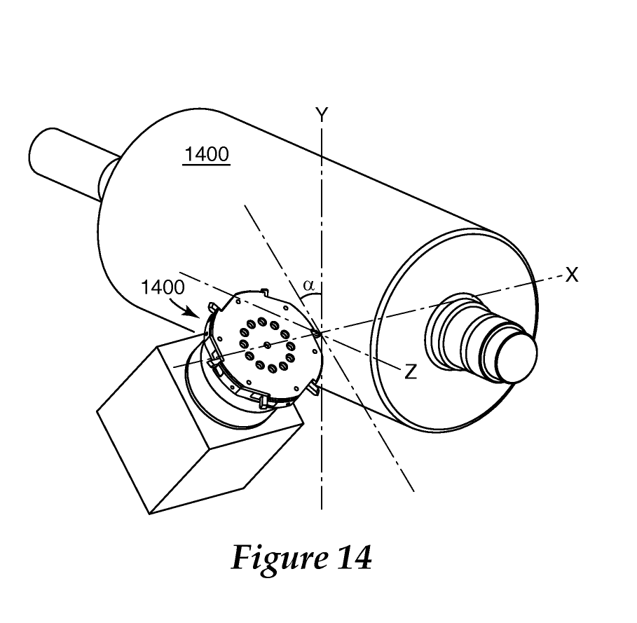

As described above grooves or features that are parallel to the z axis may be formed in or on a work piece. A variation of the same approach is to form grooves or features in a work piece at an angle to the z axis, for example by turning the fly-cutting device 45 degrees relative to its position in FIG. 12, as shown in FIG. 14, or turning the head 90 degrees relative to its position in FIG. 12, or at any other orientation. Tooling may be created with linear grooves positioned at any angle relative to the work piece, or with non-linear features or even features that intersect each other. Other angular arrangements are also possible, including sets of parallel grooves cut at different angles to produce prisms or other microstructures on the roll or work piece surface.

Forming grooves or features in a predetermined pattern in a work piece at an angle to both the y and z axes is more complex than forming them parallel to the z axis. It is more complex because the fly-cutting head is not simply advanced a fixed distance in the z direction for each revolution of the work piece to form the next groove, as with some of the other embodiments noted above. Instead, the z-direction travel of the fly-cutting head for each rotation of the work piece should be analytically or experimentally determined, so that on successive rotations of the work piece subsequent groove segments are aligned with earlier groove segments if aligned groove segments are desired. For example, if a series of 45 degree groove segments are formed around the perimeter of the roll, each be slightly advanced in the z direction relative to the previous segment, then after a complete revolution of the roll the groove segments formed during a second revolution would be parallel to the ones formed during the first revolution, but not necessarily aligned end-to-end with them. One solution to this problem is to calculate the distance by which, after a complete revolution of the roll, the groove segments formed during a second revolution should be adjusted in order to make them align end-to-end with the segments formed during the first revolution. That distance may then be divided by the number of groove segments formed during a single revolution, and the resulting fraction added to the pitch between each successive groove segment so that after a full revolution of the work piece, the groove segments formed during the second revolution have effectively precessed by the desired distance with respect to the groove segments formed during the first revolution. The same process can be used with successive revolutions.

The fly-cutting head may be angled with respect to one or more than one of the illustrated axes, and may also or instead be rotated around one or more than one of the axes, so that the cutting elements strike the work piece in a predetermined position and orientation. For example, the fly-cutting head could be rotated 90 degrees around the x axis relative to FIG. 12, so that it is aligned with the y axis, and then it could be rotated around the y axis at for example a 45 degree angle so that the cutting elements strike the work piece in a certain manner.

The ability to form grooves at an angle with respect to the longitudinal axis of a cylindrical work piece is an advantage relative to conventional cylindrical tools that include essentially linear grooves parallel or perpendicular to the longitudinal axis of the tool. This is because a user who wishes to use sheeting so that the grooves are at a 45 degree angle relative to the sides of the sheet would normally need to die-cut that sheeting at an angle from a larger piece of sheeting having grooves extending longitudinally or laterally. This can result in significant waste near the sides of the larger piece of sheeting. With the present invention, sheeting having grooves extending at a 45 degree angle (or any other selected angle) relative to the sides of the sheeting can be directly formed on a tool, with minimal waste along the sides of the sheeting when the sheeting is cut for use.

FIG. 14 illustrates an embodiment in which the fly-cutting head 1450 is arranged at an angle α relative to the y axis, enabling it to form features in the work piece 1400 at approximately a 45 degree angle relative to the longitudinal axis of the work piece 1400. The coordinate system in which the angle α is measured is arbitrary, and is not intended to limit the other positions or orientations at which the head can be positioned. The angle α can range from 0 to 360 degrees. In general, the fly-cutting head 1450 may be angled with respect to, or rotated around (or tilted with respect to), any axis.

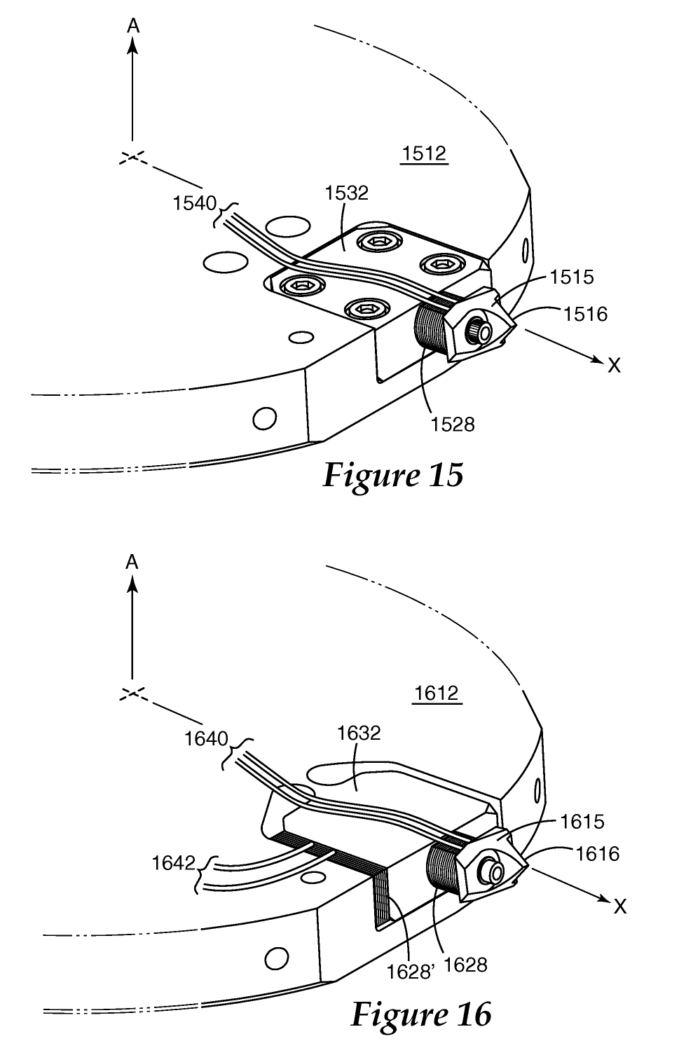

Continuous and/or discrete features as described herein can be provided through the use of any suitable fly-cutting head. The fly-cutting heads 1512, 1612 shown in FIGS. 15 and 16, respectively, includes locations at which cutting elements can be secured to the head, including in one embodiment through the use of a cartridge 1532, 1632 to which the cutting element 1516, 1616 may be secured. The head further 1512, 1612 includes an air bearing, and is coupled to a motor such as a DC motor that drives the head 1512, 1612. A rotary encoder associated with the fly-cutting head 1512, 1612 senses the rotational position of the rotating shaft that supports the head, which is useful because the position of the cutting elements can then be dynamically controlled in synchronization with their rotational position relative to the work piece, as described herein. The other characteristics of the fly-cutting head can be selected as desired. For example, a larger diameter fly-cutting head can be used to create grooves that naturally have a flatter bottom, due to the larger cutting radius, than grooves cut by a smaller diameter fly-cutting head.

The cutting element 1516, 1616 is preferably held by a cutting element cartridge or carrier 1532, 1632 and the cutting element 1516, 1616 (either alone or together with a cartridge or carrier) is positioned or repositioned using an actuator. Although a cartridge 1532, 1632 may be useful in certain embodiments of the invention to facilitate the replacement and accurate positioning of the cutting element, it may be possible to mount a cutting element 1516, 1616 directly on an actuator without such a carrier. The carrier 1532, 1632, if used, may be made of one or more of the following materials: sintered carbide, silicon nitride, silicon carbide, steel, titanium, diamond, or synthetic diamond material. The material for cutting element carrier 1532, 1632 preferably is stiff and has a low mass. The cutting element 1516, 1616 may be secured to the cutting element carrier by an adhesive, brazing, soldering, or in other ways, or directly to an actuator.

In order to produce rapid variations in the position of one or more cutting elements carried by the fly-cutting head at least one actuator 1528, 1628, 1629 is provided. The actuator 1528, 1628, 1629 may be any device that effectuates a change in position or orientation of a cutting element, and may be a component of a fast tool servo (FTS). A fast tool servo typically includes a solid state a PZT stack, which can rapidly adjust the position of a cutting tool attached to the PZT stack. PZT stacks are available that have sub-nanometer positioning resolution, and they react very quickly and exhibit essentially no wear after millions or even billions of cycles. Actuators 1528, 1628, 1629 are electrically coupled to a controller via control wires 1540, 1640, 1642. The controller may effect movement of the actuator in an open loop operation or in a closed loop operation using information from a position sensor that enables the controller to adjust for positioning discrepancies.

In one embodiment of the present invention, the actuator 1528, 1628 is positioned between the fly-cutting head 1512, 1612 and the cutting element 1516, 1616 to position or orient the latter with respect to the former. In other embodiments more than one actuator is provided and associated with each cutting element, so that the position or orientation of the cutting element can be controlled in a corresponding number of directions or orientations, or both. For example, in FIG. 16 one actuator 1628 changes the position of a cutting element along the x axis, and a second actuator 1629 changes the position of a cutting element along the z axis.

One actuator that has been shown to be useful is a PZT actuator such as the one available from the Kinetic Ceramics Company of Hayward, Calif. under the designation D1CN10, optionally with a hole drilled through the actuator to facilitate mounting. That actuator changes length in response to changes in an electrical signal, and has a maximum travel distance of approximately 9 micrometers and a resonant frequency of approximately 25 kHz (for the system, including the tool tip), or 90 kHz (for the piezo itself). A motion-amplified PZT actuator may also be useful when a longer travel distance is desired, as may a voice-coil actuator or a magnetostrictive actuator (such as one currently available from Etrema Products, Inc. of Ames, Iowa using material designated “Terfenol-D”), or other piezoelectric elements. The particular actuator(s) selected for an application depends on the displacement, frequency response, stiffness, and desired motion requirements of that application, such as rotational or bending motions.

In embodiments in which more than one cutting element is used together with the fly-cutting head, one, more than one, or all of the cutting elements may be used together with an actuator as described herein. For example, it may be useful to use a fly-cutting head having one fixed-position cutting element, and a second dynamically-controllable cutting element, so that the former tends to remove larger amounts of material from a work piece and the latter tends to form specific features within or near the feature previously formed by the fixed-position cutting element. Alternatively, in an embodiment of this type the “fixed-position” cutting element may be one that is dynamically-controllable by an actuator, but where the dynamic control feature is not used. In other words, the actuator could change the position of the cutting element, but the control system simply holds the cutting element at a fixed position. Also, a cutting element could be held in a constant position relative to the fly-cutting head during the time that the cutting element is in contact with a work piece, and then its position or orientation or both could be changed during the time that the cutting element is not in contact with the work piece.

The actuator may receive more than one signal or type of signal, through one or more wires, optical fibers, or other signal transmission devices. For example, the actuator may receive AC or DC power, to create the motive force necessary to change the position or orientation of the tool holder. The actuator may also receive a drive signal, which may be proportional to the change in position or orientation to be effectuated by the actuator. The actuator may receive a reference signal, such as a zero-voltage signal, that permits or causes it to return to its initial state, position, or orientation. Finally, the actuator or associated hardware may transmit feedback signals that provide information about the position or relative position of a tool holder or cutting element, for example, so that subsequent changes in the position or orientation of the tool holder or cutting element can be adapted appropriately. Signals of the type described, or other signals, can be transmitted through dedicated wires or optical fibers, or where appropriate they may be multiplexed along a single wire or optical fiber. The transmission of power and of the signals described herein, or any other necessary or useful signals, may also require the use of a slip ring or other mechanism for transferring signals from a stationary component to a rotating component, as is known in the art. One slip ring that may useful is available from Fabricast, Inc. of South El Monte, Calif., under the product number designation 09014. Other components for transferring power or signals, or both, include mercury wetted slip rings, fiber-optic rotary joints (FORJs), and contactless magnetic slip rings.

Another aspect of the present invention relates to compensation for the presence of a hysteresis effect associated with the actuator. The term “hysteresis effect,” as used with respect to the present invention, means that the path that an actuator (and thus a tool holder and an associated cutting element or the like) travels in one direction may not be the same path that it travels in the opposite direction, although the beginning and end point is essentially the same. If this hysteresis effect is not compensated for, then the actual shape of a feature will not correspond to the predicated shape of a feature, which can be undesirable.

One method of overcoming a hysteresis effect in a system of the type described is to use a modified signal amplifier, such as a charge-control amplifier, to control charge to the actuator instead of voltage. This is believed to result in a 10× to 20× reduction in the hysteresis effect. Another method is to use a feedback system, such as one that includes a photonic probe, to detect the position or orientation of the actuator (or the tool holder or cutting element) in both directions of travel, and to use that information to control the signals send to the actuator to compensate for the hysteresis effect. These first two methods may be used together. A third method is to adapt the waveform of the signal that is directed to the actuator to compensate for a known hysteresis effect. For example, instead of transmitting a 5 volt signal to cause the actuator to extend the tool holder a known distance, and a 0 volt signal to cause the actuator to return to its original position (though by a different path, due to the hysteresis effect), those signals can be adapted so that the “outbound” and “return” paths are essentially the same. This method is believed to work well where the same feature is to be formed in a work piece repetitively, because a single compensated waveform can be used repetitively, but not as well where successive features are different because the compensated waveform must be regenerated for each successive feature.

Signal or power transmission connections to the actuators are represented by lines 1540, 1640, and 1642, which as noted above could be for example wires or optical fibers, through which signals or power or both are transmitted from a controller to the actuator(s), and for example in the case of a feedback system, from the actuator to the controller. Due to the PZT effect and based upon the type of electric field applied, small and precise movements of the cutting element 1516, 1616 can be created. Also, the end of the actuator 1528, 1628, 1629 can be mounted against one or more Belleville washers, which provide for preloading of the actuator. The Belleville washers have some flexibility to permit movement of the actuator and a cutting element attached to it. If an actuator has multiple PZT stacks, it can use separate amplifiers to independently control each PZT stack for use in independently controlling movement of a cutting element attached to the stacks.

In certain embodiments of the present invention, the actuators selected for use are dynamically-controllable actuators. The term “dynamically-controllable” and its variations refer to the feature of the present invention that enables the position or orientation of the tool holder (and any associated cutting element) to be adjusted without stopping the fly-cutting head. In a preferred embodiment, the position or orientation, or both, of a tool holder (and any associated cutting element) may be changed during the time that the cutting element is cutting the work piece, or may be changed during the time that the cutting element is not cutting the work piece. For example, a dynamically-controllable fly-cutting head of the present invention can adjust the effective cutting path of the cutting elements when an actuator receives a signal, such as an electrical signal, that changes the effective length of the cutting element along, for example, the X axis. Dynamically-controllable fly-cutting heads may instead or in addition change the position of the cutting element(s) along other axes, or rotationally around one or more axes, or a combination of more than one of these. This is in contrast to other cutting heads that permit only static adjustment of the head to change the cutting profile, for example by using wrenches or other tools while the fly-cutting head is stopped.

The actuator may be controlled using an open-loop control system, in which a set of computer numeric control (CNC) signals are fed to the actuator to control the actuator, or a closed-loop control system in which the position of the cutting element is detected during a rotation and the position information is used continuously to create or adjust the signal used to control the actuator. Actuators of the type described herein can execute sequential instructions (based on the signals it receives) at the rate of 10 kHz or even 50 kHz or more, and accordingly incremental adjustments in the cutting path can be made to provide surface features that exhibit very fine resolution, or features that have not in the past been readily created using a fly-cutting system. On the other hand, the actuators may be used to execute low-speed signals of 0 Hz (in the case of a fixed signal, in which the position and orientation of the cutting tip are not dynamically controlled) or more.

In another embodiment of the present invention, the dynamic-control actuation feature of the present invention is synchronized with the position of the work piece to obtain certain particularly beneficial effects. That is, instead of activating the dynamically-controllable actuator according to a fixed set of instructions regardless of the position of the cutting element, the position of the cutting element is synchronized with the position of the roll. In one embodiment, the rotational position of a roll is coordinated (synchronized) with the z axis position of the fly-cutting head, which varies within a predetermined range so as to produce groove segments in the roll that are non-linear, and the x-axis position of the cutting element(s) is or are coordinated with the rotational position of the fly-cutting head. The x-axis variation in the position of the cutting elements, which can be regular or irregular can produce groove segments having depths and/or widths that vary, which may be used to produce a tool having grooves with varying height and/or pitch.

It is believed that because cutting elements experience wear, and wear will result in subtle changes in the characteristics of the features cut into a roll, a close inspection of the roll or a work piece formed on the roll can indicate whether the sequence of groove segments were created along the z axis of the roll, as noted first above, or along the perimeter, as noted second. In other words, using the z-axis cutting method described first above, the cutting element(s) would wear as each sequential groove was cut, so that by the time the final groove was cut alongside the first groove, the last groove formed by the worn cutting element may appear noticeably different than the first groove formed by an unworn or less-worn cutting element, at least on a micro-scale. This may be referred to as a “virtual seam,” because of the difference between two adjacent grooves or other features.

Using the peripheral cutting method described second above, where small individual groove segments are formed around the perimeter of the roll, the features formed by the unworn or less-worn cutting element would be at the first end of the roll, and the features formed by the worn cutting element would appear at the second end of the roll. Rolls having the “virtual seam” and rolls having the “end-to-end” wear patterns described above, as well as the methods of forming them and sheeting or other goods made using them are all within the scope of the present invention.

The fly-cutting techniques illustrated in FIGS. 11-16 may be used to cut base structures and/or modifying features by various methods. For example, cutting the base structures and the modifying features may be performed in a two step process that involves fly-cutting base structures initially and then fly-cutting modifying features such that the modifying features are superimposed on the base features. Alternatively, the modifying features may be fly-cut in the surface of the master surface initially, followed by a step that fly-cuts the base structures over the modifying features.

Additional aspects regarding the use of fly-cutting which may be applied to cutting base features and/or modifying optical features as described herein may be found in commonly owned U.S. Patent Applications identified by Attorney Docket No. 62782US002 and Attorney Docket No. 63327US002 both filed Aug. 6, 2007.

In some embodiments, two different cutting processes may be used together to cut the base structures and the modifying features. For example, in one embodiment, the base structures are formed using a turning machine and the modifying features are formed by fly-cutting. Alternatively, the base structures may be made by fly-cutting with the modifying features made by the turning machine.

Optical films fabricated having superimposed base structures and modifying features are particularly useful to create light directing films having enhanced optical characteristics. For example, light directing films in accordance with embodiments of the invention may comprise an array of linear triangular prisms arranged substantially parallel that provide brightness enhancement by directing or recycling light. Abruptly discontinuous discrete features superimposed on the linear prisms provide enhanced diffusion and defect hiding characteristics. In some embodiments, the base features and/or the modifying features may incorporate a plurality of additional diffraction elements that further enhance diffusion characteristics of the films. These additional diffraction elements may comprise planar or curved shapes that modify the geometry of the base and/or modifying features. For example, if used in conjunction with the base structures, the diffraction elements may modify the geometry of one or more sides of the feature, the top and/or bottom of the feature. Alternatively or additionally, diffraction elements may be used in conjunction with the modifying features to modify the surface of the features, thereby increasing the light scattering of the modifying features. The diffraction elements can be formed using tool tips with the desired geometry. Tool tips such as those illustrated herein may be employed for cutting base structures and/or modifying features using turning machine or fly-cutting techniques.

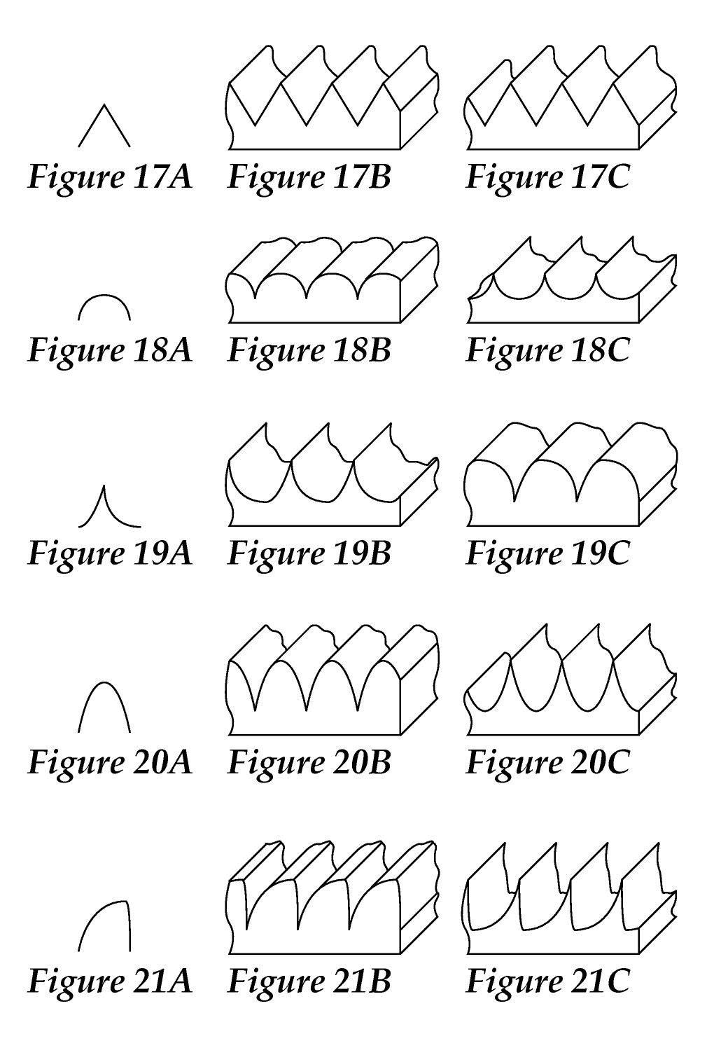

In turning machine and fly-cutting processes the shape of the tool tip imparts a characteristic shape to the features formed using the tool tip. FIGS. 17-21 illustrate views of tool tip geometries (FIGS. 17A, 18A, 19A, 20A, 21A), portions of micro-replication master tools cut using the corresponding tool tips (FIGS. 17B, 18B, 19B, 20B, 21B), and the portions of optical films (FIGS. 17C, 18C, 19C, 20C, 21C) having continuous base structures formed using the corresponding master tools. The tool tips illustrated are particularly applicable to turning machine applications, but may be used in either turning machine or fly-cutting applications. For simplicity, the modifying features are not shown in these views. The base structures formed in the optical film may include one or more sides that are substantially planar (FIGS. 17, 20, 21) or one or more curved sides (FIGS. 19). Peaks of the base structures may be sharp (FIGS. 17, 18, 20, 21) or flattened (FIGS. 18 and 20). The base structures need not be symmetrical (FIG. 21). Before or after formation of the base features as illustrated in FIGS. 17-21, modifying features may be formed using the same, or different, tool tip geometries.

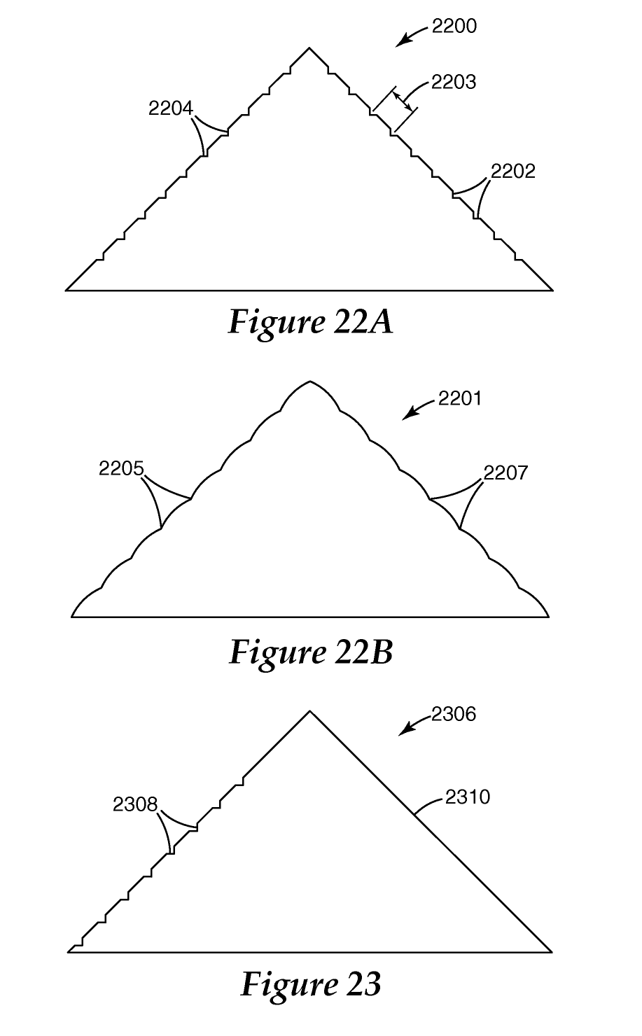

FIGS. 22-31 are views of exemplary geometries that include diffraction elements. Tool tips incorporating these geometries may be used to impart additional diffraction elements to base structures and/or modifying features. For example, tool tips exhibiting the exemplary geometries may be used in turning machine applications to create the corresponding structures in micro-replication master tools which are in turn used in the fabrication of films. The geometries may also be implemented in fly-cutting applications. The geometries illustrated herein are not necessarily shown to scale. Rather, they are intended to show examples of shapes and configurations of features and structures that provide for diffraction. The features can have any dimension and spacing depending upon desired characteristics.

In some embodiments, diffractive elements refer to features in a film or article causing diffraction of light or to features in a tool that, when used to make a film or article, result in diffractive features in the film or article. As described above, the film or article having the diffractive elements are made from a master tool having the corresponding diffractive features. The diffractive features can be tuned to obtain a desired amount of diffraction in a film or article made from the master tool. In particular, the size and shape of the diffractive elements, along with the spacing between the diffractive elements, can be designed for the amount or degree of diffraction of light desired for a particular application. For example, as the spacing between the diffractive elements decreases, the diffractive elements cause increasing diffraction of light. Therefore, diffractive elements spaced farther apart cause less diffraction, and diffractive elements spaced more closely together cause more diffraction. In certain embodiments, for example, the diffractive elements, such as grooves, can be spaced within 10 microns, 5 microns, 1 micron, or within a distance near a particular wavelength of light. In one embodiment, the diffractive elements include multiple features having a substantially triangular cross-sectional shape and having a spacing of 650 nm between them. For example, one embodiment includes 28 such features each spaced approximately 650 nm apart. In some embodiments, diffractive features refer to nano-scale features. For example, the diffractive elements can have a size on the order of 100 nm or even as small as 10 nm. The size of the diffractive elements on the tool tip results in substantially the same size of diffractive elements in films, as illustrated below, made from a work piece machined with a diffractive tool tip.

Tool tips having the geometries shown in FIGS. 22-31 can be implemented with, for example, a diamond slab. The diffractive elements on the tool tips can be made preferably via ion milling. Other techniques to make diffractive features on tool tips include micro electrical discharge machining, grinding, lapping, ablation, or other ways to impart scratches or features into the tool tip. Alternatively, diamonds can be lapped in a traditional fashion and bonded precisely together to make a macro tool assembly having diffractive features. As an alternative to an indenting diffractive feature, machined tool tips can have protruding diffractive features, or a combination of indenting and protruding diffractive features.

A master tool can be machined to incorporate geometries shown in FIGS. 22-31, and the master tool can be used to make films as described above. For example, the master can be machined to produce continuous base features and/or discrete modifying features that also include the diffractive geometries illustrated in FIGS. 22-31. Optical films made from the master tool have complementary geometries and can be made to have unique diffractive and refractive optical power. An exemplary purpose of the these unique diffractive and refractive optical forms in enhancement films is to provide more options for moving light out of the central viewing zone with more versatility than simply putting a radius on the tip of a tool.

The master tool can be achieved through plunge or thread cutting with the ion milled diamond, as described above. Plunge and thread cutting are described in U.S. Pat. Nos. 7,140,812 and 6,707,611. In films made from the master tool machined with these tool tips, the diffractive elements do not have to be present on every base feature or modifying feature of the films. For example, plunge cutting can be used to interleave base features and/or modifying features having diffraction elements with base features and/or modifying features that do not have diffraction elements. In some embodiments, the diffractive features can be present on only one of the facets of a prism. This type of tool tip allows for finer optical tuning of the luminance profile. The diffractive elements also facilitate a smoother cut-off, or luminance profile, in optical films such as BEF. The diffraction elements can also facilitate cutting time reduction for optical films when compared to the use of multiple tool tips to separately create the base and/or modifying features and the diffractive elements.

FIG. 22A illustrates a cross sectional geometry 2200 that can be used to provide diffractive elements 2202 and 2204 on both facets. The diffractive elements 2202 and 2204 are shown as V-grooves or notches in this example. The grating spacing 2203 between diffractive elements can be constant or varied to produce different properties that would be of value or interest. For example, by varying the grating spacing, one could smooth the divergence profile in corresponding optical films as compared to a constant grating spacing. This spacing can also help with wavelength dependence and ameliorate color effects. The shape of the ion milled grating does not have to be V-shaped, although negative draft angles should typically be avoided. The width and depth of the grating grooves or notches will usually be less than one micron but could be greater than one micron. There are many shapes which could be utilized to produce the notches or grooves. For visible light applications, the distance 2203 between grating grooves will usually be in the 0.5 micron to 10 micron spacing range, although other ranges may be used to meet design goals.

A diamond tool was produced using this design with the diffractive elements 2202 and 2204 being 5 microns apart (distance 2203) and with each diffractive element having a width of 1 micron across the groove. In this case, the diffractive grooves were shown to provide controlled scattering of the light away from the region of refractive, transmitted maxima which cut off at approximately 31° in the film samples. The diffractive elements of this film were shown to smoothly broaden the luminance profile using photometric measurements with a goniometer. The luminance profile can be tuned by making the grating spacing greater and reducing the number of grooves or features. Alternatively, decreasing the grating spacing and increasing the number of grooves or elements can also be used to fine tune the profile.

FIG. 22B illustrates a cross-sectional geometry 2201 that can be used to provide diffractive elements 2205 and 2207 on both facets. The geometry 2201 illustrated in FIG. 22B is a variation of that presented in FIG. 22A in that the diffractive elements 2205 and 2207 are separated by curved portions rather than flat portions. The examples of ion milled diamond forms, described below for FIGS. 23-31, illustrate other embodiments for tuning the luminance profile.

FIG. 23 illustrates geometry 2306 with diffractive elements 2308 on one facet and no elements on the other facet 2310. Diffractive elements 2308 may comprise V-grooves or notches and have a constant or variable grating spacing.

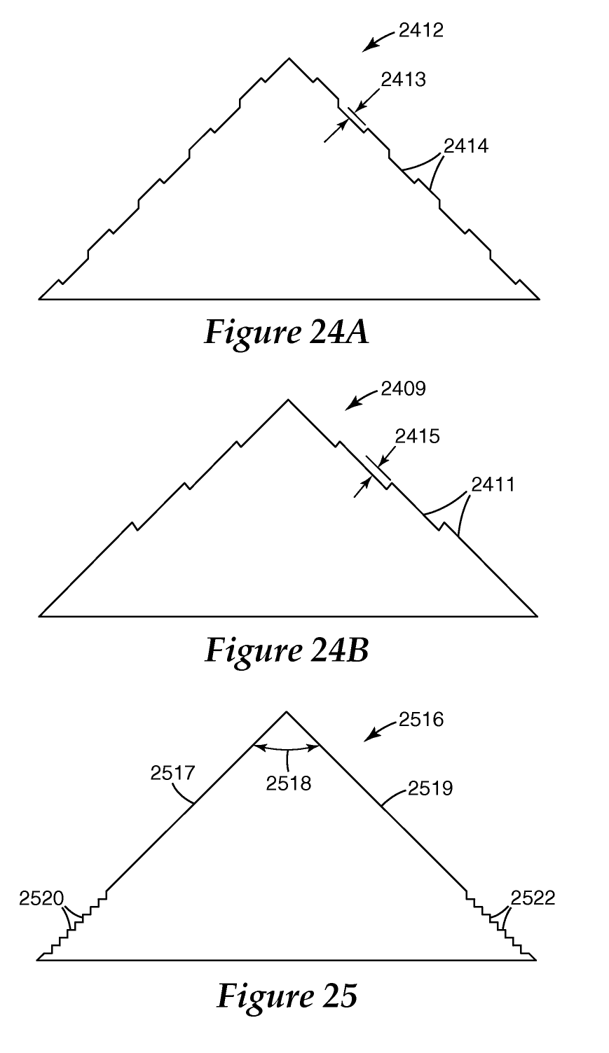

FIG. 24A illustrates geometry 2412 with diffractive elements 2414 using a step height variation 2413, which may be constant or varying among the elements.

FIG. 24B illustrates geometry 2409 with diffractive elements 2411 using a step height variation 2415, which may be constant or varying among the elements. Tool tip 2409 is a variation of the configuration of tool tip 2412 in that the diffractive elements 2411 have a single angled step height variation rather than step height variations on both sides of the diffractive elements.

FIG. 25 illustrates geometry tool tip 2516 with diffractive elements 2520 and 2522 along 90° (2518) facet sides 2517 and 2519. Diffractive elements 2520 and 2522 can be near the tip or near the valley (away from the tip) as appropriate to the design or as desired. Also, the diffractive elements 2520 and 2522 can be located arbitrarily along the 90° facet walls.

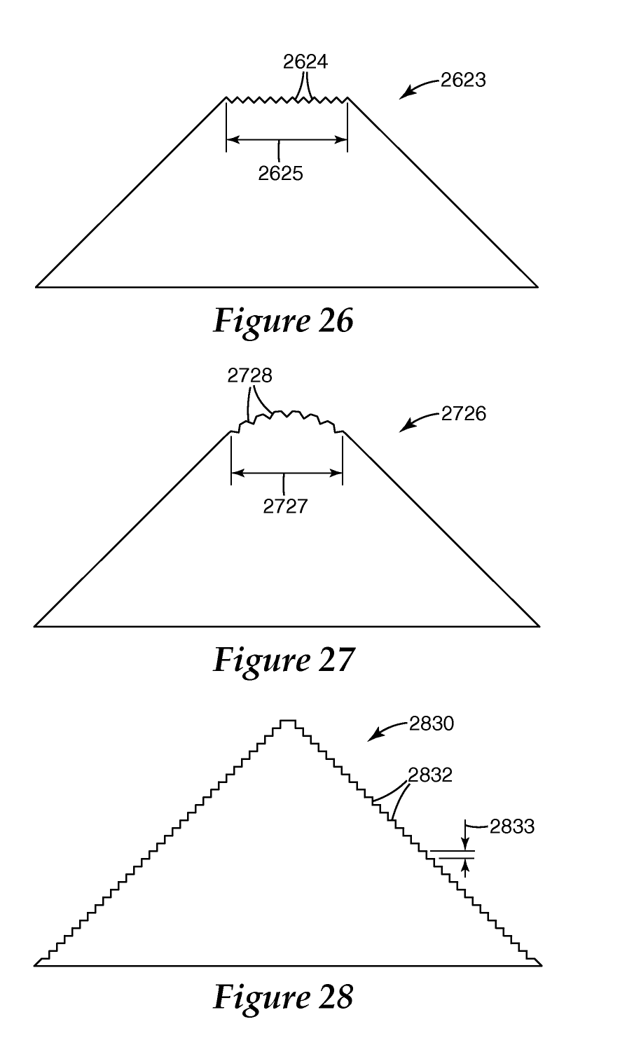

FIG. 26 illustrates geometry 2623 with diffractive elements 2624 along a flat tip 2625. In one example, this type of configuration of diffractive elements on a tool tip was made from a diamond having a 10 micron width (2625) with 11 V-grooves (2624) spaced 1 micron apart.

FIG. 27 illustrates geometry 2726 with diffractive elements 2728 along a curved tip 2727.

FIG. 28 illustrates geometry 2830 with diffractive elements 2832 formed in steps having a height 2833 along 90° facets, for example.

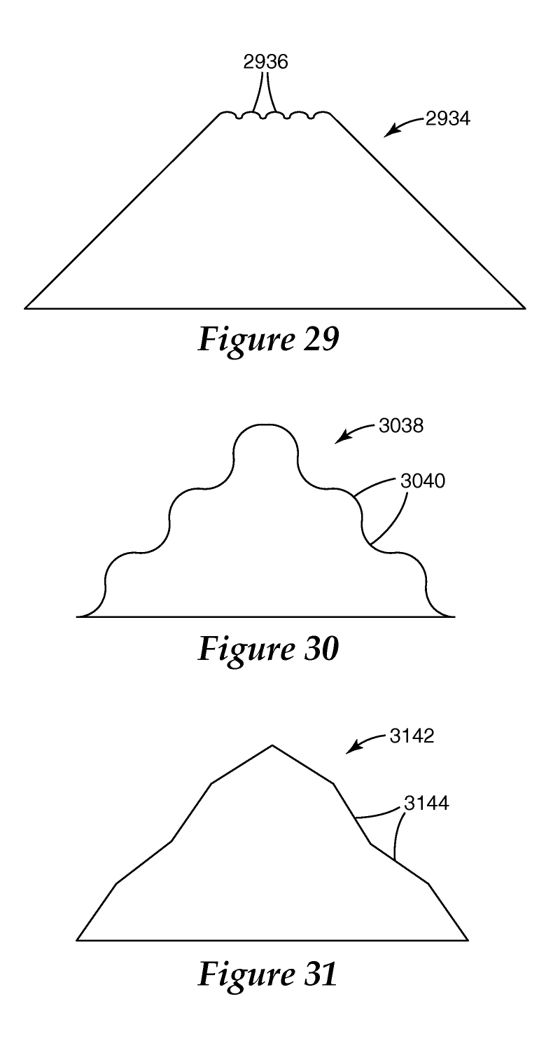

FIG. 29 illustrates geometry 2934 with diffractive elements 2936 having a lenticular shape along a substantially flat portion of the tool tip.

FIG. 30 illustrates geometry 3038 with diffractive elements along curved facets 3040 formed from adjacent concave and convex portions along the facets.

FIG. 31 illustrates geometry 3142 with diffractive elements along multiple linear facets 3144 formed from adjacent angular flat portions along the facets.

The use of geometries such as those described above may be used to make micro-replicated articles, such as films, having diffractive elements that can provide for many advantageous or desirable characteristics. For example, they can be used in light management applications for light direction, softening cutoff angles, extraction of light for light guides, or decorative effects on existing features such as rainbow effects on interrupted cut lenslets. Also, a diffractive element on a larger microstructure provides for an additional degree of freedom for redirecting light.

The geometries described above can be used to make features on a macro-scale (dimensions of 1 micron and above) and a nano-scale (dimensions less than 1 micron), and the features can be made using one or more tool tips in a continuous and/or interrupted cut mode. In addition, the cutting using the tool tips can be accomplished in an x-direction, a y-direction, or a z-direction into the tool, or a combination of those directions, Alternatively, the diffractive elements can be cut in the tool without use of an actuator, which can involve continuous cutting with the tool tip(s) held at a substantially constant or a non-constant depth in the surface of the tool using, for example, a low frequency servo.

As previously discussed, in some embodiments, the micro-replication master, and films created using the master, may include features having variation of features caused by cutting tool movement along the x-axis, the z-axis or both. These variations in pitch and/or height may be introduced into the films to ameliorate various optical defects that commonly occur. Variation in the prism pitch advantageously reduces the appearance of Moiré interference patterns in optical films Variation in prism height advantageously reduces the occurrence of wetout regions.

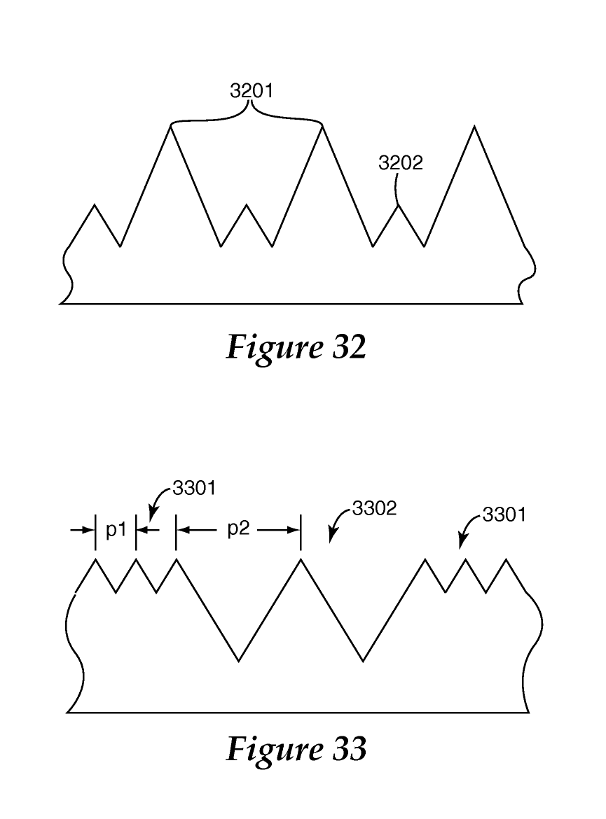

In some embodiments, continuous base features exhibiting variations in x and/or z directions may be superimposed with abruptly discontinuous discrete features. Movement of the cutting tool movement in the x direction can be used to produce geometries characterized by feature-to feature patterns of taller features 3201 (corresponding to deeper grooves in the master) and shorter features 3202 (corresponding to shallower grooves in the master) as illustrated in FIG. 32. Movement of the cutting tool in the z direction can be used to produce geometries characterized by feature-to-feature patterns having variations in pitch as illustrated in FIG. 33. In FIG. 33, a first set of features 3301 have pitch, p₁, and a second set of features 3302 have pitch p₂. Note that, as previously described, the variations that occur from feature-to-feature or along any particular feature may be regular or irregular. Regular patterns may be period or aperiodic. Features having various characteristics may be interleaved.

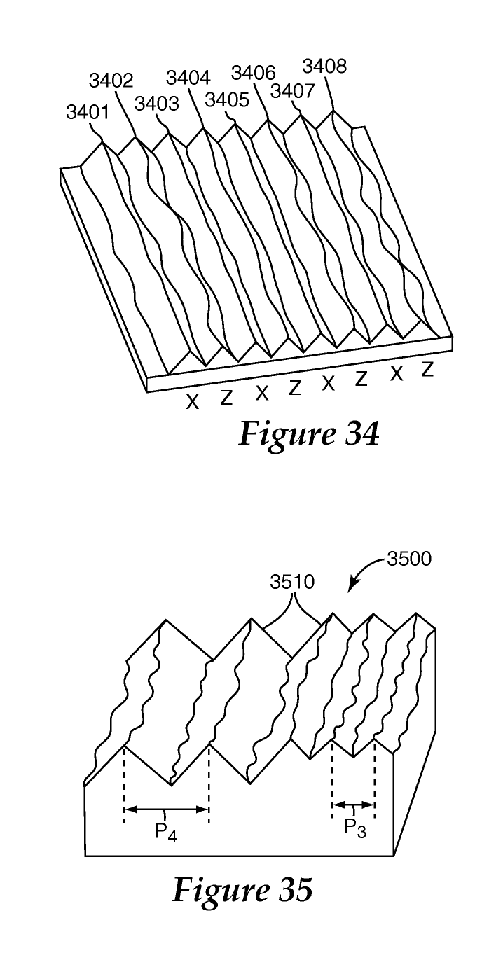

In some embodiments, base structures exhibiting variations in x and/or z directions along the features may be superimposed with abruptly discontinuous modifying features. Movement of the cutting tool in the x and/or z directions may be used to produce feature variations that occur along a particular feature. FIG. 34 illustrates features 3401, 3403, 3405, 3407 that vary in height along the feature length interleaved with features 3402, 3404, 3406, 3408 that vary in pitch along the feature length. Other embodiments may incorporate variations in pitch without the height variations or variations in height without the pitch variations.

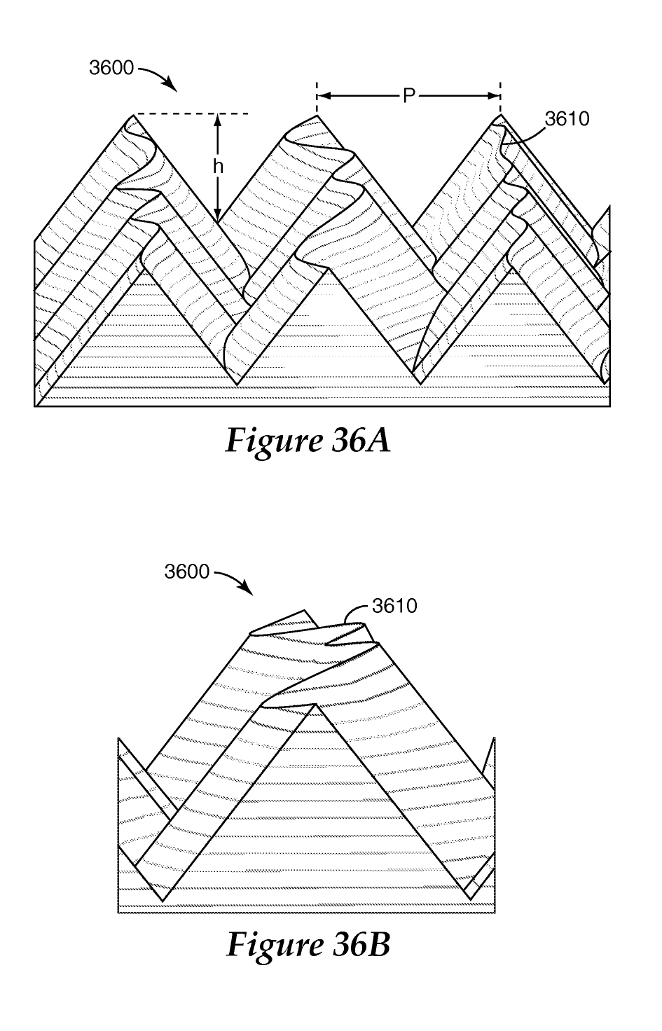

In some embodiments relatively fast, continuous variations in the cutting tool movement in the x and/or z directions may be used along with slower continuous variations in the x and/or z directions. FIG. 35 illustrates an embodiment, wherein z direction movement of the cutting tool produces feature-to-feature variations in pitch such that p₃≠p₄. More rapid movement of the cutting tool in the x direction produces variations in height along each of the features 3510.

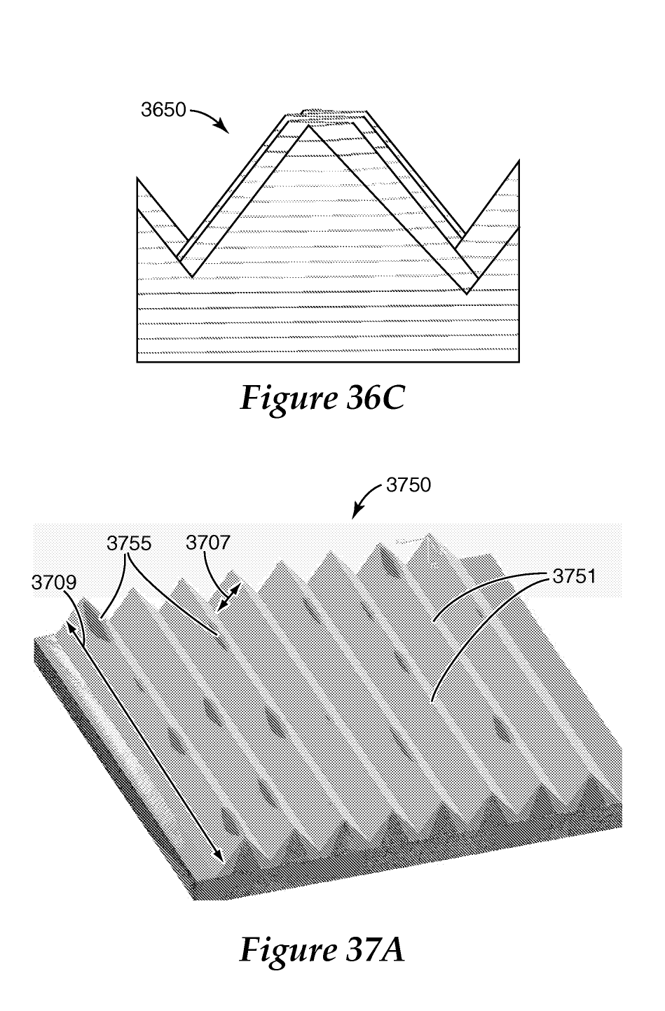

In some embodiments, both high frequency z direction movement and high frequency x direction movement of the cutting tool is used to create the base features and/or modifying features of micro-replication masters and optical films. These structures may be achieved by cutting tool movement as the result of first and second actuators that produce movement along the x and z axes, respectively. A cutting head that includes two actuators is illustrated in FIG. 6A. Structures having both x and z variations may also be achieved through the use of a single axis actuator that cuts along a trajectory having both an x component and a z component. A cutting head configure for this type of trajectory cutting is illustrated in FIG. 9A, FIGS. 36A and 36B illustrate a base structure 3600 having x and z-axis excursions formed by cutting along a trajectory. The lines depicted on the structures of FIGS. 36A-36C are intended to more clearly illustrate height variations of the prisms. The structure 3600 includes prisms 3610 providing both anti-Moiré variations in prism pitch, p, and anti-wetout variations in prism height, h. FIG. 36B is a cross-sectional view of the prism peaks 3610 of the prism film 3600 of FIG. 36A illustrating the variations in prism height and pitch. For comparison, FIG. 36C is a cross-sectional view of a structure 3650 having prisms with only pitch variations without height variations.

Embodiments of the invention are directed to processes that involve the formation of superimposed base structures and modifying features in micro-replication master tools and/or films created therefrom. For example, the base features in accordance with embodiments of the invention may have a constant x-axis and/or z-axis dimension, or may have a variable x-axis or z-axis dimension. Possible variations in the x-axis and/or z-axis dimension of the features may include slow or fast variations. The base structures and/or modifying features may include various diffraction elements as illustrated in FIGS. 17-31. For example, base features illustrated in the shapes illustrated in FIGS. 32-36 may include diffractive elements in some embodiments. In some embodiments, modifying features may include the diffractive elements and in some embodiments both the base structures and the modifying features may include diffractive elements. In addition, features having certain characteristics or particular types of diffractive elements may be interleaved in any pattern with those having other characteristics or other types of diffractive features. The base structures, modifying features and/or diffractive elements may be cut into the surface of a master using any combination of turning machine cutting, fly-cutting, and/or other processing methods. The feature pattern, density, area, depth, and proportion of base structures, modifying features, and/or diffractive elements may be adjusted for optimized film performance.

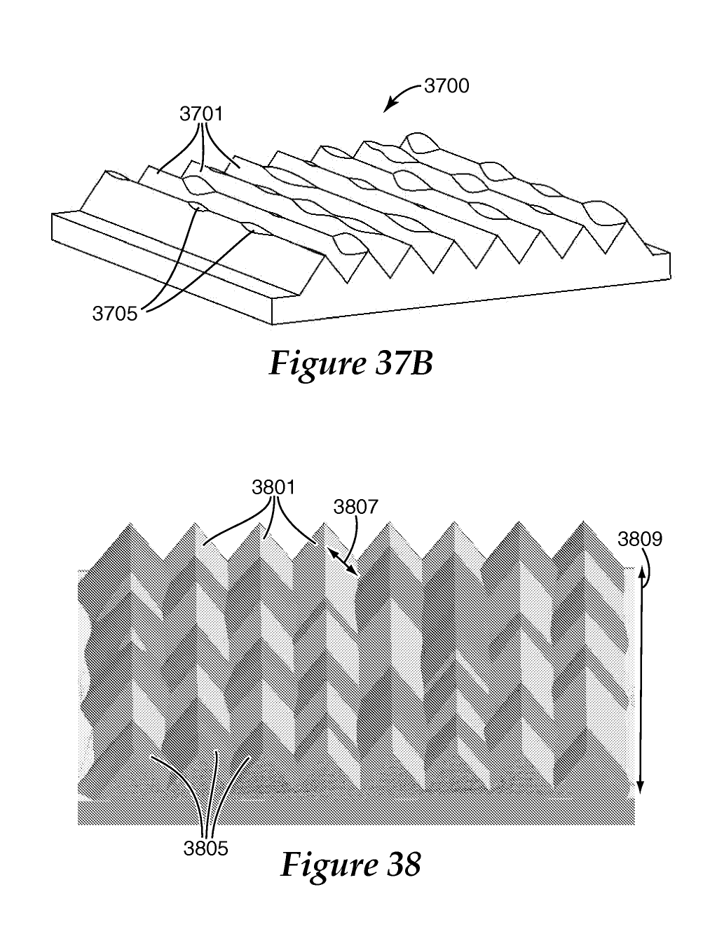

FIGS. 37-44 illustrate exemplary configurations of superimposed base structures and modifying features that may be used in conjunction with various embodiments, although it will be apparent to those skilled in the art upon reading the present disclosure that many additional combinations of base structures and modifying features are possible.

FIGS. 37A and 37B illustrate prism films that include a base structure with modifying structures superimposed in a random pattern wherein the modifying features produce randomly located regions of greater peak height. The base structures may comprise sharp peaked prisms as illustrated in FIG. 37A or the base structure prisms may have radiused peaks. The modifying features may have radiused peaks as illustrated in FIG. 37A, or may have sharp peaks as illustrated in FIG. 37B. Either or both of the base structures and the modifying features may include diffraction elements. In the embodiments illustrated in FIGS. 37A and 37B, the modifying features modify the sides of the base features 3751 in discrete regions that involve substantially less than a majority of the peak-to-valley distance 3707 of the base structures 3751 and along less than a majority of the length 3709 of the base features 3751.

FIG. 37A illustrates a structure of a prism film 3750 which also corresponds to the complementary structure of the master tool used to form the film 3750. As illustrated in FIG. 37A, he master tool structure can be formed by cutting continuous base structures 3751 followed by cutting modifying features 3755 using a cutting tool having a different cutting tool profile than the cutting tool profile used for the base features, wherein the modifying cut incises deeper into the surface of the master in the x-direction. Prism film 3750 may be formed by thread cutting sharp tipped prisms as the base structures 3751. A second cutting tool profile, having a narrower included angle than the profile used for the base structures and radiused tip, is used to cut irregularly placed modifying features 3755 that increase the peak-to-valley depth of the base features 3751. For example, the base structures 3751 may have an internal angle of about 90°, or between about 40° and about 150° and the modifying features may have an internal angle of about 40°. The cutting tool tip used to make the modifying features may have a radius, for example, a radius of about 3 microns to about 8 microns, in order to preserve the facet as much as possible but add durability.

As a practical matter, all cutting tool tips and/or prism peaks have some measure of radius, and thus the terms “sharp tipped” and “radiused tipped” may be applied to prism peaks in relation to other prism peaks. For example in a configuration including peaks of two different radii, the “sharp-tipped peaks” may be denoted as such in relation to other peaks, the “radiused tipped peaks,” that have a larger radius.

In some embodiments, the base features and/or the modifying features may additionally include diffraction elements, such as the elements illustrated in FIGS. 22-31. In some embodiments, the base features may be cut with a radiused cutting tool profile. A radiused tip profile enhances the toughness of the prisms but may reduce gain in a brightness enhancement film. Therefore in some applications, it may be advantageous to cut with a radiused tip profile for the discrete, irregularly placed, modifying features. The particular structure illustrated in FIG. 35A substantially preserves the overall gain of the optical film while providing anti-wetout variations in peak height. The use of a radiused or flattened tool profile to form the modifying structures makes these anti-wetout structures more durable by radiusing or blunting the relatively fragile peak tips.

The use of interrupted cutting to form the modifying features, e.g., by plunge cutting, allows the formation of discrete regions which are defined by a perimeter where an abruptly discontinuous change in slope of the underlying base structure occurs. Interrupted cutting on an underlying base structure involves superimposing multiple cutting waveforms, such as superimposing the waveform associated with the interrupted cuts with a continuous waveform. This approach can be used to achieve abrupt discontinuities having a taper in or taper out angle (or change in slope per micron) of more than about 0.1 degrees, more than about 0.2 degrees or more than about 1 degree, for example. Each modifying feature may elevate the peak of the underlying base structure by about 0.5 microns to about 3 microns, for example. The modifying features may range from less than one micron to tens of microns.

The abrupt change in height allows the formation of small, discrete micro-structures superimposed on a base structure that is many times larger. Reduction in the length or area of individual modifying features and/or controlling the overall ratio of modifying feature length or area to base feature length or area, for example, facilitate the ability to obtain or maintain gain and/or other character of an optical film. For example, in brightness enhancement films using sharp tipped triangular prisms, it may be desirable to maximize the area of the base features (sharp tipped prisms) to preserve gain, while also providing small regions of modifying structures (taller, radiused tipped peaks) that serve as lamination standoffs and/or anti-wetout features. The advantageous combination of continuous sharp tipped prisms and small, radiused tipped discrete features is possible by superimposing the cutting profile of the underlying continuous prism structure with that of the discrete modifying structures.

Controlling the length and/or overall area of the individual modifying features provides the ability to control the contact area between the film and an adjacent film which is desirable in many applications. Enhancements in preserving gain and/or reducing contact area are achievable using the approaches described herein due to the ability to produce abrupt transitions in height at the perimeter of the modifying features. The use of abruptly discontinuous modifying features enhances the ability to optimally design a film to comply with multi-parametric specifications, such as specifications of gain, light direction, film toughness, optical diffusion, defect hiding capability, and anti-defect features, and other film characteristics, for example.

In some embodiments, as illustrated in FIG. 37A, the base structures 3701 and modifying features 3705 are formed in the master using synchronized fly-cutting methods as described in more detail herein. Groove structures may be formed radially around the work piece, along the cylindrical axis of the work piece or in a direction having any angular bias with respect to the work piece's cylindrical axis. In these embodiments, multiple passes of the fly-cutter head could be implemented to form the discrete features. Alternatively, multiple cutting tools on one fly-cutter head could form the discrete features. The cutting tools used to form the discrete features could be actuated via fast tool servos (FTS), for example, to form perimeters of the discrete features that are abruptly discontinuous from the underlying shape of the continuous features.

In some embodiments, thread cutting and synchronized fly-cutting methods may be used in combination to cut both the initial base grooves and the discrete modifying features. For example, in the example of FIG. 37A, thread cutting could be used initially to create the continuous grooves 3751 followed by synchronized fly-cutting to form the discrete modifying features 3755. Formation of the base structures and/or modifying features may rely on multiple passes of cutting tools across the surface or on a single pass of multiple cutting tools.

Conversely, fly-cutting methods could be initially used to create the base structures with thread cutting methods then employed to subsequently form the discrete modifying features. FTS actuation of the cutting tool or tools facilitates formation of modifying features that have abruptly discontinuous perimeters.

FIG. 37B illustrates a structure of a prism film 3700 which also corresponds to the complementary structure of the master tool used to form the film 3700. In this example, sharp tipped prisms form the base structures 3701. For example, the base features may have an internal angle of about 90° or other angle. Discrete, modifying features 3705 are formed by incising more deeply in the x direction along the peaks of the base features 3701. The modifying features 3705 are formed using a sharp tipped cutting tool in this embodiment. For example, the internal angle of the modifying features 3705 may be about 40° or other angle.

FIG. 38 illustrates a structure of a prism film 3800 which also corresponds to the structure of the master tool used to form the film 3800. In this example, base features 3801 and modifying 3805 features may be formed by the continuous and interrupted cutting techniques as previously described. For example, the base structures 3801 may be formed via using continuous cutting technique which does not include FTS operation. The modifying features 3805 may be formed by making interrupted cuts via a dynamic cutting process wherein the cutting tool is moved using an x-axis FTS actuator. The base and modifying features 3801, 3805 can be formed using the same cutting tool profile geometry. The interrupted cuts which form the modifying features 3805 incise deeper into the surface of the master along the grooves that form the continuous base structures 3801. In this example, the modifying features increase the height of the prisms (corresponding to the depth of the grooves on the master surface). In addition, the modifying features 3805 also modify the sides of the base structures 3801 along a majority of the peak-to-valley distance 3807 of the base structures 3801 in discrete regions that extend less than a majority of the length 3809 of the base structures 3801. In some embodiments, the modifying features 3805 may modify the sides of the base structures 3801 along substantially all of the peak to valley distance 3807. The proportion of base structures 3801 to modifying features 3805 may be adjusted to achieve desired characteristics of the optical film. In some embodiments, one or both of the base structures and the modifying features may be cut with a radiused tipped cutting tool. The percentage of the overall area of the regions of modifying features to the unmodified base structures to, e.g., 25%, 35%, or other amount, may be selected to provide a specified gain, defect hiding ability, and film toughness, for example.

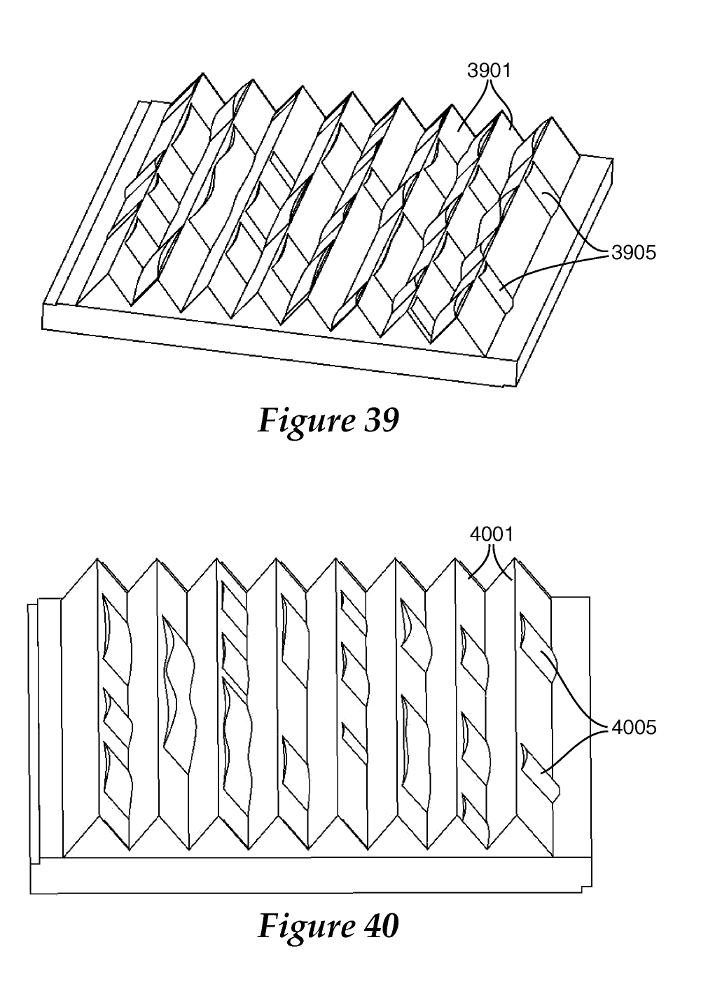

In some embodiments, the discrete features are formed by motion of the cutting tool laterally in the z direction along the master. FIG. 39 illustrates the structure of a prism film 3900 which also corresponds to the structure of the master tool used to form the film 3900. The film 3900 includes base structures 3901 corresponding to elongated grooves cut into the master such as with a cutting process that forms grooves having substantially constant depth and pitch. During one or more subsequent cutting steps, a cutting tool, which may have the same geometry or a different geometry as the tool used to cut the base structures, is moved along the z-axis by an FTS actuator to incise deeper into the sides of the grooves. The resultant film comprises modifying features 3905 that modify the slope of the continuous features 3701 at locations along the sides of the grooves 3901. The peaks of the base structures 3901 may or may not be affected by the z axis incisions.

In some embodiments, the modifying features may be formed by movement of the cutting tool by trajectory cutting along both the x and the z directions. For example, as illustrated in FIG. 40, the modifying features 4005 may be formed by trajectory cutting using a single axis actuator according to the process illustrated in FIGS. 9A-9E or by using separate x and z actuators to move the cutting tool. Trajectory cutting may or may not affect the peaks of the base structures 4001. As illustrated in FIG. 40, the modifying features 4005 may be asymmetrically formed on only one side of the grooves 4001.

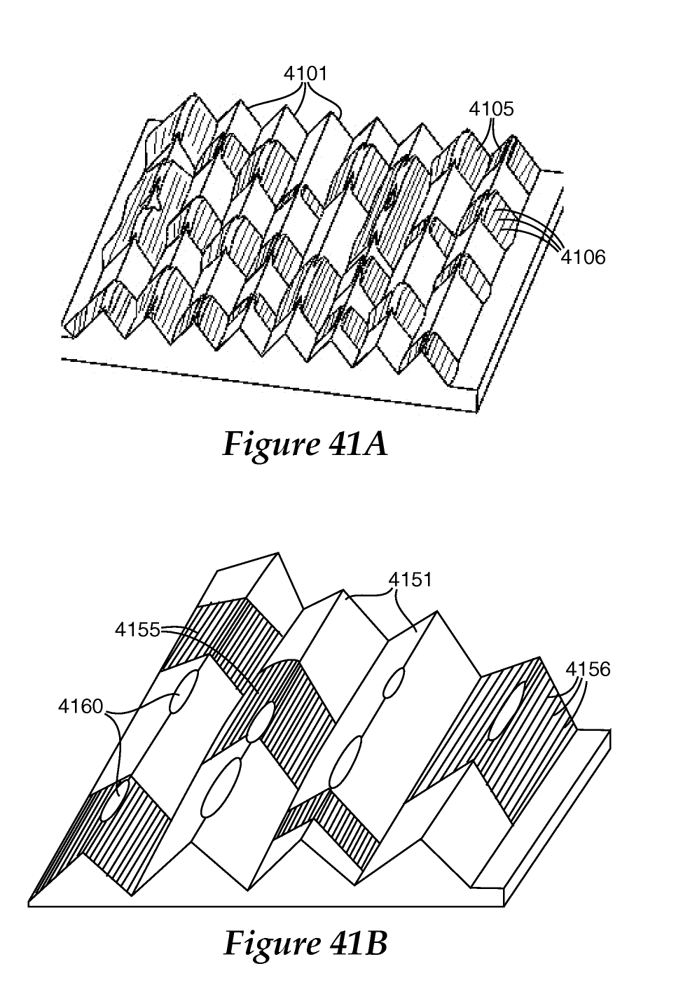

Either the base structures, the modifying features, or both, may additionally include diffraction elements as previously described in connection with FIGS. 22-31. FIG. 41A illustrates an embodiment in which the base structures 4101 comprise sharp-tipped peaks that do not include diffraction elements, and the modifying features 4105 include radiused peaks. One or more of the modifying features 4105 includes diffraction elements 4106. The modifying features 4105 are formed by a cutting tool that incises more deeply in the x direction at regular or irregular locations along the continuous grooves forming the base structures 4101. Diffraction elements may be used on only some of the modifying features and the same diffraction element pattern need not be used for each modifying feature. For example, modifying features having one pattern of diffraction elements may be interleaved with one or more other modifying features having no diffraction elements or a different pattern of diffraction elements. In the example illustrated in FIG. 41A, the modifying features 4105 affect both the peaks of the base structures 4101 and the sides along at least a majority of the facet along the peak-to-valley distance at discrete locations along the base structures 4101. In some embodiments the modifying features may affect the tops of the base structures predominantly or exclusively, or may affect the sides of the base structures predominantly or exclusively.

FIG. 41B illustrates a structure of a prism film that includes two types of modifying features superimposed on the base structures. In this example, the base structures 4151 have sharp tipped peaks. A first type of modifying feature 4155 includes sharp tipped peaks and diffraction elements 4156. A second type of modifying feature 4160 comprises radiused peaks. The configuration illustrated in FIG. 41B may be formed in a master tool by first cutting the grooved base structure used to form the sharp tipped peaks 4151, followed by the first modifying features 4155 having diffraction elements 4156 and finally the cutting the radiused features 4160. Note that the radiused features 4160 may or may not appear concurrently with features 4155 having diffraction elements.

Base structures and/or the modifying features (or portions of the base structures and/or the modifying features) may take a variety of shapes. For example, either or both of the base structures and the modifying features may include curved, convex, concave, or faceted sides and/or curved, convex, concave, or faceted peaks. There may be morphological diversity among the base structures and/or modifying features in that not every base structure exhibits the same shape and/or not every modifying feature modifies the base structure in the same way. As examples, consider that one or more types of modifying features may appear concurrently or separately along each of the base structures, one or more types of modifying features may be interleaved from base structure to base structure, one or more types of base structure may be interleaved, or the base structures and modifying features may appear in a variety of other combinations. Modifying features having a plurality of shapes may be superimposed randomly, semi-randomly, or in any other pattern on the base structures.

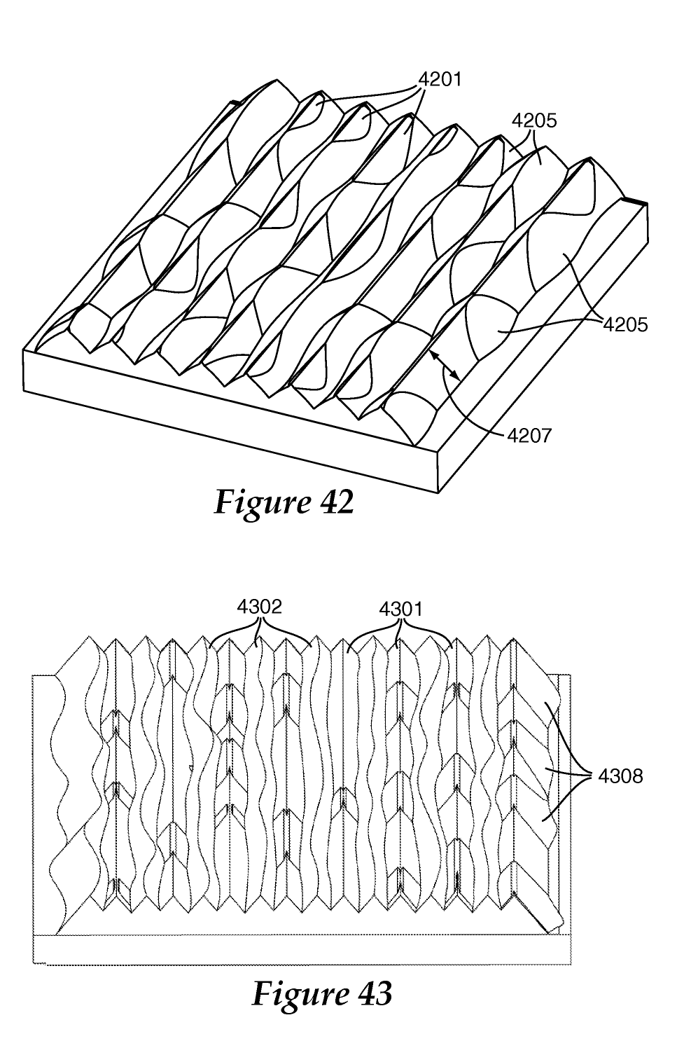

FIG. 42 illustrates a configuration wherein the base structures 4201 are triangular prisms and the modifying features 4205 include curved sides that extend over a major portion of the facet of the base structures along the peak-to-valley distance 4207 of the base structures 4201. In some configurations, the modifying features modify the base structures over substantially all of the facet along the peak-to-valley distance 4207. In this example, the modifying features 4205 have generally curved or rounded sides forming a “gothic arch” shape. The gothic arch shape is illustrated, for example, by the top portion of the cutting tool tip shown in FIG. 2B. The configuration of FIG. 42 is particularly useful to spread light while also maintaining higher optical gain. The enhanced light spreading ability is advantageous for bulb hiding, and reduces light punch through which can cause bright spots in regions just above the light source.

FIG. 43 illustrates a configuration that includes modifying features superimposed on base structures. The modified base structures are interleaved with an additional prism type. The configuration illustrated in FIG. 43 includes base structures 4301 comprising triangular prisms with sharp peaks. Superimposed with the base structures 4301 are irregularly placed modifying features 4308 having radiused peaks. Interleaved with the modified base structures 4301 are prisms 4302 that introduce prism pitch variations.

The configuration illustrated in FIG. 43 may be achieved by first cutting the grooves for the linear prisms, in a next step, superimposing the modifying features on the grooves, and then finally interleaving grooves formed using a variation in the z-axis movement of the cutting tool. The order of these steps may be rearranged. The steps may be performed by multiple passes of a cutting head over the master tool surface or may be performed in a single pass using multiple cutting tools, some of which are dynamically controlled, mounted on one cutting head as illustrated in the turning system of FIG. 10 or the fly-cutting system of FIG. 11. Trajectory cutting may be used to form the prism pitch variations, which also interjects variations in prism height along the secondary prisms 4302. Prism configurations such as the one illustrated in FIG. 43 advantageously include both anti-wetout elements formed by the increased height produced by the modifying features 4308 and anti-Moiré elements formed by the variations in prism pitch provided by the interleaved prisms.

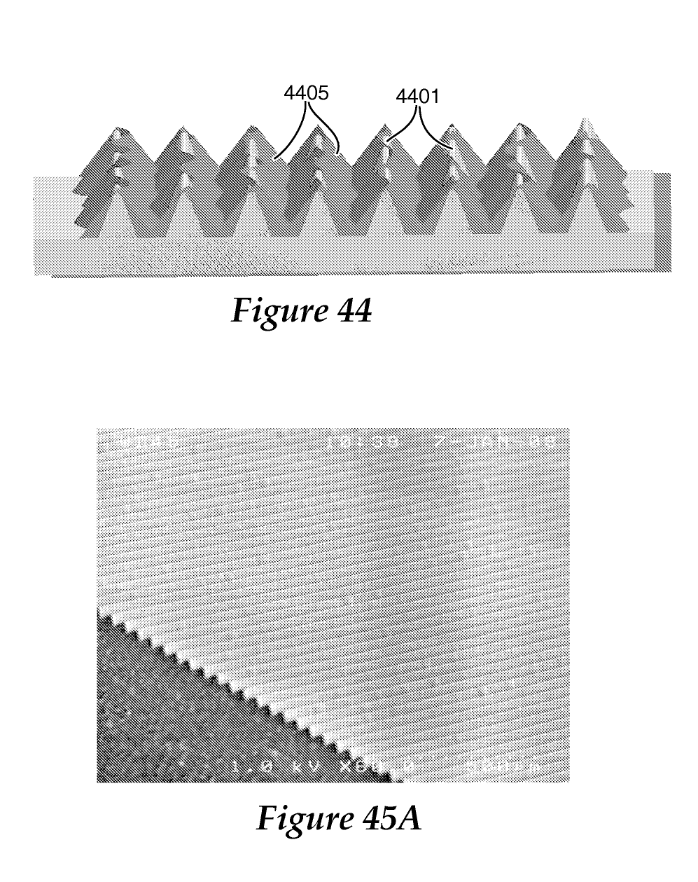

In the optical film illustrated in FIG. 44, the base structures 4401 comprise triangular prisms with variations in peak height and having radiused tipped peaks, although sharp peaks, flattened or blunt tips may be used. The continuous cut having z-axis motion forms continuous modifying features 4405 in the prism film. This process can produce a film that includes variations in peak height which is useful for anti-wetout, increased peak radius which improves durability, and/or variations in peak pitch along the grooves, which is useful for anti-Moiré. In some embodiments, the modifying features 4405 may be formed using a tool having a flattened or blunt peak. Another useful structure is formed by recutting the straight grooves with a continuous motion using the trajectory cutting technique described herein.

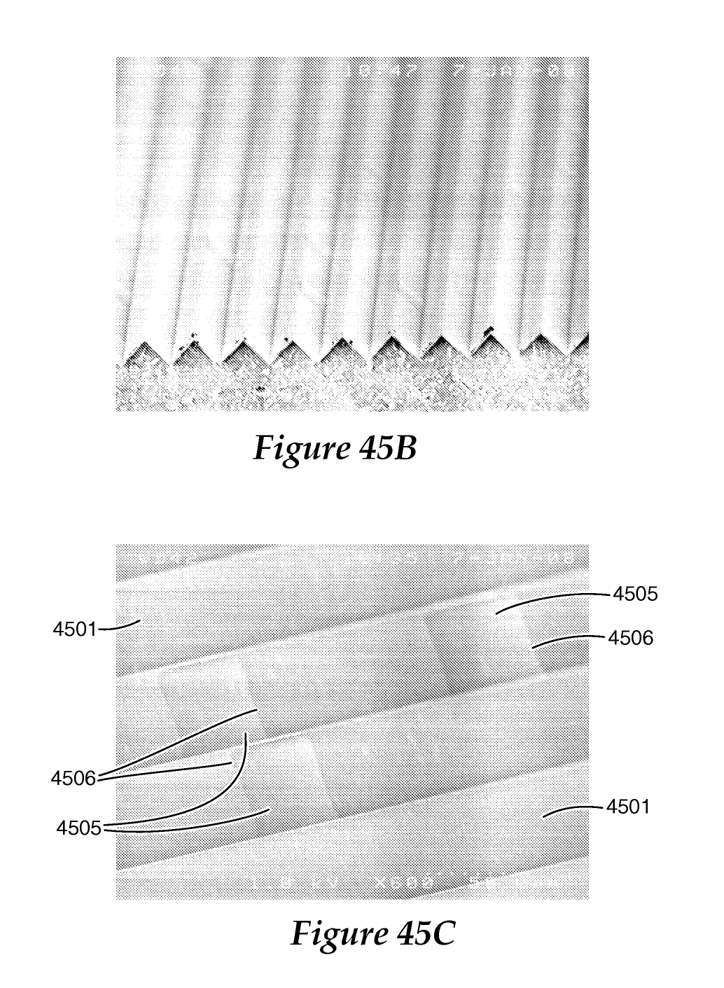

FIGS. 45A-45C show photographic views at different magnifications of a film comprising a series of base prism structures superimposed with modifying features. As is best seen in FIG. 45C, the modifying features 4505 comprise discrete regions defined by a perimeter 4506 that exhibits an abrupt discontinuity in the shape of the base structures 4501. The modifying features 4505 can be used in conjunction with the base structures 4501 to provide enhanced diffusion characteristics, improved durability, reduction of defects and/or defect hiding for various types of optical films including brightness enhancement films that utilize a series of continuous substantially linear prisms.

Master tools and/or films made from master tools according to embodiments of the present invention may include one or more of the features, structures, methods, or combinations thereof described herein. For example, optical films, master tools, and systems and methods used to manufacture these components may be implemented to include one or more of the advantageous features and/or processes described. It is intended that such optical films and master tools, along with systems and methods used to form such components, need not include all of the features described herein, but may be implemented to include selected features that provide for useful structures and/or functionality.

Optical films having abruptly discontinuous regions that modify the height, slope or, generally, the shape, of the surrounding optical features may be used to control various characteristics of the optical films. Films having regions of taller features are useful for providing anti-wetout features, making the film more durable (i.e., less susceptible to scratches), and for modifying the film's intensity distribution to provide more light at higher angles, for example. In brightness enhancement films, sharper tipped prisms, i.e., prisms having a smaller included angle or radius, result in higher gain. By varying the relative amount of smaller included angle prisms with prisms having larger internal angles, a desired balance between gain, durability, bulb hiding, and anti-wetout features may be obtained for a given application. Additionally, irregularly placed discrete features can be used to mitigate Moiré effects caused by regular placement of continuous features.

In some embodiments, the base structures may be modified asymmetrically, e.g., by inclusion of modifying features predominantly or exclusively on one side or facet of the base structures. These embodiments are particularly useful when asymmetrical optical characteristics are desired, such as to achieve or support a preferred direction of light from the film. Asymmetrical light direction may be desirable, for example, in a display for a hand held device, where it is expected that the user is looking downward toward the device, and brightness of the display is optimized by directing light upward toward the viewer.

The techniques described herein provide a number of advantages, for example, over multi-start side-by-side cutting of continuous optical film prisms which has been employed to provide different prism structures on the same work piece. The multi-start side-by-side cutting method includes a fixed proportion of prism shapes (i.e., for two passes, 50% one shape and 50% a second shape) which may not be optimal for optical performance or manufacturing constraints. Further, this method produces a regular pattern of prism shapes (i.e., for two passes, every other prism being the same) which may not be optimal for mitigation of Moiré pattern or defect hiding.

For example, if both sharp-tipped and radius-tipped prisms of greater peak-to-valley height are desirable in a film construction, two pass multi-start side-by-side cutting methods could be used to create this geometry. However, the construction would be limited to 50% radius-tipped prisms and 50% sharp-tipped prisms in an every other prism array. The 50% ratio may not be optimal for balancing durability and optical performance and the regular array pattern could cause Moiré issues. The use of base structures modified in regular or irregular patterns may be used to address these issues and produce superior film configurations.

Optical film manufacturing processes in accordance with the various embodiments have the advantages of being able to produce BEF film with randomly placed features in any proportion across the area of the film. Additionally, the modifying features may be added in such a manner to generally preserve the underlying structure of the existing BEF facets, thereby preserving on axis gain of the film. The modifying features may be implemented to include anti-wetout features, anti-Moiré features, durability features, lamination standoffs, bulb hiding, defect hiding features, diffusion features, and/or diffraction features, any of which could improve optical film characteristics for different applications. Optimizing the proportion of the modifying features with respect to the underlying base structure may be used to help balance optical performance issues with mechanical, manufacturing, and/or environmental issues.

For example, interrupted cutting processes that produce discrete features in conjunction with continuous base structure prisms allow formation of standoffs that reduce interactions in layered prism film constructions. Further, the proportion and/or location of these standoff features can be optimized to balance laminate adhesion, optical performance, and Moiré mitigation. The use of brightness enhancement films as a durable first surface film in monitors is another example where films formed as described herein would be particularly advantageous. As stated previously, the use of regularly or irregularly placed radiused, flattened, or blunt-tipped modifying features could be introduced to improve film durability and improve scratch resistance. The proportion and location of the rounded or flattened features could be optimized to balance durability with optical performance while at the same time mitigating Moiré effects.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An optical film, comprising:
one or more base optical structures, each base structure having a peak; and
a plurality of modifying features superimposed on the base structures, each feature modifying a region of an underlying base structure by elevating the peak of the underlying base structure in the region, wherein the elevated peaks have a radius that is different from a radius of the peak of the underlying base structure.

2. The optical film of claim 1, wherein each modifying feature has a perimeter associated with an abrupt discontinuity in a slope of the underlying base structure.

3. The optical film of claim 2, wherein the abrupt discontinuity comprises a change in slope in excess of about 0.1 degrees over 1 micron.

4. The optical film of claim 3, wherein each feature elevates the peak of the underlying base structure in excess of about 0.5 microns.

5. The optical film of claim 1, wherein:
peaks of the base structures have an internal angle in a range of about 40 degrees to about 150 degrees; and
the peaks of the modifying features have radius in a range of about 3 microns to about 8 microns.

6. The optical film of claim 1, further comprising diffraction elements disposed on one or both of the base structures and the modifying features.

7. The optical film of claim 1, wherein at least some of the base structures vary in pitch.

8. The optical film of claim 1, wherein at least some of the base structures vary in height.

9. The optical film of claim 1, wherein at least some of the base structures vary in pitch and height.

10. The optical film of claim 1, further comprising a plurality of additional features that modify one or more sides of the base structures and do not substantially modify the peaks of the base structures.

11. The optical film of claim 1, wherein:
the base structures comprise linear triangular prisms that have opposing sides; and
the modifying features modify at least one facet of each of the prisms along a majority of the peak-to-valley distance of the facet and less than a majority of the length of the prism.

12. An optical film, comprising:
one or more base optical structures, each base structure having a peak; and
a plurality of modifying features superimposed on the base structures, each modifying feature elevating a peak in a region of an underlying base structure, the elevated peaks having a peak radius that is substantially equal to a radius of the peak of the underlying base structure.

13. The optical film of claim 12, wherein each modifying feature has a perimeter associated with an abrupt discontinuity of the underlying base structure.

14. The optical film of claim 13, wherein the abrupt discontinuity comprises a change in slope in excess of about 0.1 degrees over 1 micron.

15. The optical film of claim 12, wherein each modifying feature elevates the peak of the underlying base structure more than about 0.5 microns.

16. The optical film of claim 12, further comprising diffraction elements disposed on one or both of the base structures and the modifying features.

17. The optical film of claim 12, wherein at least some of the base structures vary in pitch.

18. The optical film of claim 12, wherein at least some of the base structures vary in height.

19. The optical film of claim 12, further comprising a plurality of additional features that modify sides of the base structures and do not substantially modify the peaks of the base structures.

20. The optical film of claim 12, wherein:
the base structures comprise linear triangular prisms that have opposing facets; and
the modifying features modify at least one facet of each of the prisms over a majority of the peak-to-valley distance of the facets over less than a majority of the length of the prisms.

21. An optical film, comprising:
one or more base structures, each base structure having opposing sides and a peak; and
a plurality of discrete features superimposed on the base structures, each feature modifying a slope of at least one side of an underlying base structure for less than a majority of a length of the underlying base structure and without substantially modifying the peak of the underlying base structure.

22. The optical film of claim 21, wherein each feature comprises a region having a perimeter associated with an abrupt discontinuity of the underlying base structure.

23. The optical film of claim 22, wherein the abrupt discontinuity is associated with a taper angle in excess of about 1 degree.

24. The optical film of claim 21, wherein each feature modifies the sides of the underlying base structure along a majority of the peak-to-valley distance of the sides.

25. The optical film of claim 21, wherein one side of each underlying base structure is devoid of the features.

26. An optical film, comprising:
one or more base optical structures, each base structure having opposing sides, a length, and a peak; and
a plurality of features superimposed on the base structures, each feature modifying an underlying base structure along a majority of a peak-to-valley distance of at least one side of the underlying base structure and less than a majority of the length of the underlying base structure.

27. The optical film of claim 26, wherein one or more of the features modify both sides of the underlying base structure.

28. The optical film of claim 27, wherein one of more of the modifying features elevate the peak of the underlying base structure in discrete regions.

29. The optical film of claim 28, wherein a radius of the peaks in the discrete regions is different from a radius of the peak of the underlying base structure.

30. The optical film of claim 28, wherein a radius of the peaks in the discrete regions is greater than a radius of the peak of the underlying base structure.

31. The optical film of claim 28, wherein a radius of the peaks in the discrete regions is less than a radius of the peak of the underlying base structure.

32. The optical film of claim 26, wherein diffraction elements are disposed on one or both of the modifying features and the base structures.

33. The optical film of claim 26, wherein there is an abrupt discontinuity at a perimeter between each modifying feature and the underlying base structure, the abrupt discontinuity associated with a taper angle in excess of 1 degree.

34. A method of modifying a surface to form a master tool for making optical films, comprising:
cutting a base structure in the surface of the master tool, the base structure comprising a groove in the surface of the master; and
cutting one or more modifying features in the surface of the master, wherein the base structure and the modifying features are superimposed to produce abruptly discontinuous variations along the groove.

35. The method of claim 34, wherein:
cutting the base structure comprises cutting a continuous groove; and
cutting the modifying features comprises cutting one more discrete features that modify the continuous groove.

36. The method of claim 34, wherein cutting the modifying features comprises cutting the modifying features after cutting the base structure.

37. The method of claim 34, wherein cutting the base structures comprises cutting the base structures after cutting the modifying features.

38. The method of claim 34, wherein cutting the base structure comprises cutting diffraction elements in the base structure.

39. The method of claim 34, wherein cutting the modifying features comprises cutting diffraction elements in at least some of the modifying features.

40. The method of claim 34, wherein cutting the modifying features comprises moving a cutting tool to cause the cutting tool to incise more deeply into the groove, wherein movement of the cutting tool includes a component substantially normal to the surface of the master tool.

41. The method of claim 34, wherein cutting the modifying features comprises moving a cutting tool to cause the cutting tool to incise more deeply into one or both sides of the groove, wherein movement of the cutting tool includes a component substantially parallel to the surface of the master tool.

42. The method of claim 34, wherein cutting the modifying features comprises moving the cutting tool along a trajectory that includes a component parallel to the surface of master tool and a component normal to the surface of the master tool.

43. The method of claim 34, wherein cutting the modifying features comprises cutting discrete features that change the slope of one or both sides of the groove without modifying a depth of the groove.

44. The method of claim 34, wherein the abruptly discontinuous variations comprise variations in taper angle greater than 1 degree.

45. The method of claim 34, wherein the modifying features produce abruptly discontinuous variations in groove depth in excess of 0.5 microns.

46. The method of claim 34, wherein cutting one or more of the base structure and the modifying features comprises synchronized fly-cutting.

47. The method of claim 34, wherein cutting one or more of the base structure and the modifying features comprises dynamic synchronized fly-cutting.

48. The method of claim 34, wherein cutting one or more of the base structure and the modifying features comprises plunge cutting.

49. The method of claim 34, wherein cutting one or more of the base structure and the modifying features comprises thread cutting.

50. The method of claim 34, wherein:
cutting the base feature comprises cutting the base structure using a cutting tool having a first cutting tool profile; and
cutting the modifying features comprises cutting the modifying features using a cutting tool having a second cutting tool profile different from the first cutting tool profile.

51. The method of claim 50, wherein the first cutting tool profile has a cutting tip radius that is less than a cutting tip radius of the second cutting tool profile.

52. The method of claim 34, wherein cutting one or more of the base structure and the modifying features comprises cutting using a cutting tool having a radiused, flattened, or blunted cutting tool profile.

53. The method of claim 34, wherein cutting the base structure and cutting the modifying features comprises cutting the base structure and the modifying features by moving first and second cutting tools together in a single pass of a cutting head across the surface.

54. A system for modifying a surface to form a master for making optical films, comprising:
one or more cutting tools;
a drive system configured to provide relative motion between the one or more cutting tools and the surface; and
a cutting mechanism configured to control the cutting tools to cut a base structure in the surface of the master and to cut modifying features along the groove wherein the base structure and the modifying features are superimposed to produce abruptly discontinuous variations in a shape of the base structure.

55. The system of claim 54, wherein the cutting mechanism comprises a synchronized fly-cutting mechanism configured to control the cutting tools to make one or both of the base structure and the modifying features by synchronized fly-cutting.

56. The system of claim 55, wherein the synchronized fly-cutting mechanism is a dynamic synchronized fly-cutting mechanism.

57. The system of claim 54, wherein the cutting mechanism includes one or more cutting tools having a first profile used to cut the base structure and one or more second cutting tools having a second profile used to cut the modifying features.

58. The system of claim 57, wherein at least one of the first profile and the second profile comprises a radiused, flattened or blunted tip.

59. The system of claim 54, wherein the cutting mechanism is configured to cut the base structure and the modifying features during a single pass of the cutting tools across the surface.

60. The system of claim 54, wherein the cutting mechanism is configured to cut the base structure during one or more first passes of the cutting tools across the surface and to cut the modifying features during one or more second passes of the cutting tools across the surface.

61. A master tool useable for fabricating optical films, the master tool having a surface, comprising:
a plurality of grooves disposed on the surface; and
features modifying the grooves, each feature extending for less than a length of an associated groove and encompassing a region defined by an abrupt discontinuity in a slope of the associated groove.

62. The master tool of claim 61, wherein the abrupt discontinuity has a taper angle in excess of 1 degree

63. The master tool of claim 61, wherein at least one feature modifies a depth of the associated groove and has an internal angle that is different from an internal angle of the associated groove.

64. The master tool of claim 61, wherein at least one feature modifies a depth of the associated groove and an internal radius that is different from an internal radius of the associated groove.

65. The master tool of claim 61, wherein at least one feature modifies a depth of the associated groove and has an internal radius that is smaller than an internal radius of the associated groove.

66. The master tool of claim 61, wherein at least some of the features modify sides of the grooves without modifying depths of the grooves.

67. The master tool of claim 61, wherein at least some of the grooves vary in one or both of pitch and depth.

68. The master tool of claim 61, wherein at least some of the features modify at least one side of each groove along a majority of the peak-to-valley distance of the groove.

69. The master tool of claim 61, wherein at least some of the features do not modify a depth of the grooves.

70. A system for modifying a surface to form a master for making optical films, comprising:
a first cutting tool configured to prepare the surface;
a second cutting tool configured to cut features in the surface;
a drive system configured to provide relative motion between the cutting tools and the surface; and
a cutting mechanism configured to move the first cutting tool and the second cutting tool to prepare the surface and cut the features during a single pass of the cutting tools across the surface.

71. The system of claim 70, wherein the roughness of the surface after preparing the surface is substantially less than a smallest feature.
